(19) United States
(12) Patent Application Publication
(10) Pub. No.: US 2026/0260199 A1
(43) Pub. Date: Sep. 3, 2026

(54) SYSTEMS AND METHODS OF FACILITATING AUTOMATED REGULATORY COMPLIANCE DETERMINATION

(71) Applicant: William Gardner Smith, Monroe, LA (US)

(72) Inventor: William Gardner Smith, Monroe, LA (US)

(21) Appl. No.: 19/537,185

(22) Filed: Feb. 11, 2026

Related U.S. Application Data
(60) Provisional application No. 63/740,042, filed on Dec. 30, 2024.

(51) Int. Cl. G06Q 10/0639; G06F 9/50; G06N 10/60; G06Q 10/067; H04L 9/08

(52) U.S. Cl. CPC G06Q 10/06393; G06F 9/505; G06N 10/60; G06Q 10/067; H04L 9/0852

(57) ABSTRACT

The present disclosure provides a method of facilitating automated regulatory compliance determination. Further, the method may include receiving, using a communication device, a compliance input data from a regulatory data source. Further, the method may include receiving, using the communication device, an operational input data from an enterprise system. Further, the method may include determining, using a processing device, a compliance status data by processing the compliance input data and the operational input data using a quantum-inspired neural network. Further, the method may include generating, using the processing device, a compliance output data based on the compliance status data. Further, the method may include storing, using a storage device, the compliance output data. Further, the method may include transmitting, using the communication device, the compliance output data to a client system.

### FIELD OF DISCLOSURE

The present disclosure generally relates to data processing. More specifically, the present disclosure relates to systems and methods of facilitating automated regulatory compliance determination.

### BACKGROUND

The present disclosure relates generally to the field of computer-implemented regulatory compliance technologies, and more particularly to software-based platforms that support regulatory compliance analysis, governance, and oversight in complex digital and enterprise computing environments. As organizations increasingly rely on distributed computing systems, cloud-based services, and data-driven operations, regulatory compliance has become a critical component of operational integrity, risk management, and trust. Compliance requirements span financial governance, cybersecurity, environmental protection, workplace safety, and other regulated domains, and failure to comply may result in legal exposure, financial penalties, operational disruption, and reputational harm. Accordingly, the ability to manage and assess regulatory compliance in a reliable and scalable manner is of significant importance across industries.

A desirable objective in this field is to facilitate automated and continuous determination of regulatory compliance in a manner that can accommodate evolving regulatory requirements, diverse operational contexts, and large volumes of heterogeneous data, while maintaining availability, accuracy, and system performance. Such an objective is particularly relevant for software-as-a-service environments, where compliance functionality must be delivered remotely, on demand, and across multiple enterprises with differing regulatory obligations.

However, existing approaches to regulatory compliance determination suffer from a number of technical and practical limitations that hinder achievement of this objective. Many known systems rely on static rule-based frameworks that require manual configuration and periodic updates, which limits their ability to adapt to regulatory changes in a timely manner. Such systems often process compliance data in batch-oriented or sequential workflows, leading to latency, inefficiency, and delayed compliance insights. In addition, conventional compliance solutions frequently lack the ability to interpret operational data in context, resulting in over inclusive or under inclusive compliance assessments that reduce accuracy and usefulness.

Further, existing systems may struggle to scale effectively as regulatory data volume, complexity, and velocity increase, particularly in cloud-based or distributed environments. Resource utilization may be inefficient due to rigid allocation models that do not account for variable compliance processing demand. Moreover, many known approaches provide limited transparency into how compliance determinations are produced, making it difficult to verify, audit, or reproduce results. Security concerns also arise when sensitive regulatory or operational data is processed, as existing solutions may not adequately protect such data during active computation or analysis.

Additionally, interoperability challenges persist, as compliance outputs are often generated in formats that are not readily consumable by downstream systems, regulators, or auditing tools. The inability to produce standardized, machine-readable compliance information can increase integration complexity and operational burden. Collectively, these shortcomings make it difficult for existing methods and systems to support continuous, adaptive, secure, and scalable regulatory compliance determination in modern computing environments.

Therefore, there is a need for improved methods and systems for facilitating automated regulatory compliance determination that can overcome one or more of the preceding problems.

### SUMMARY OF DISCLOSURE

This summary is provided to introduce selected concepts in a simplified form. The concepts are further described in the Detailed Description. The summary is not intended to identify essential features of the claimed subject matter, nor is it intended to limit the scope of the claims.

The present disclosure provides a method of facilitating automated regulatory compliance determination. Further, the method may include receiving, using a communication device, a compliance input data from a regulatory data source. Further, the method may include receiving, using the communication device, an operational input data from an enterprise system. Further, the method may include determining, using a processing device, a compliance status data by processing the compliance input data and the operational input data using a quantum-inspired neural network. Further, the method may include generating, using the processing device, a compliance output data based on the compliance status data. Further, the method may include storing, using a storage device, the compliance output data. Further, the method may include transmitting, using the communication device, the compliance output data to a client system.

The present disclosure provides a system for facilitating automated regulatory compliance determination. Further, the system may include a communication device. Further, the communication device may be configured for receiving a compliance input data from a regulatory data source. Further, the communication device may be configured for receiving an operational input data from an enterprise system. Further, the communication device may be configured for transmitting a compliance output data to a client system. Further, the system may include a processing device. Further, the processing device may be configured for determining a compliance status data by processing the compliance input data and the operational input data using a quantum-inspired neural network. Further, the processing device may be configured for generating the compliance output data based on the compliance status data. Further, the system may include a storage device which may be configured for storing the compliance output data.

Both the foregoing summary and the following description provide illustrative examples and are not limiting. Features described in connection with one embodiment may be combined with features of another embodiment unless stated otherwise or unless such combination would be incompatible.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram of a machine-learning system 300 for implementing various embodiments of this disclosure, in accordance with some embodiments.

FIG. 4 illustrates a flowchart of a method 400 of facilitating automated regulatory compliance determination, in accordance with some embodiments.

FIG. 5 illustrates a flowchart of a method 500 of facilitating automated regulatory compliance determination including updating, using the processing device 1404, the compliance status data without interrupting availability of the method, in accordance with some embodiments.

FIG. 6 illustrates a flowchart of a method 600 of facilitating automated regulatory compliance determination including refining, using the processing device 1404, determination of the compliance status data, in accordance with some embodiments.

FIG. 7 illustrates a flowchart of a method 700 of facilitating automated regulatory compliance determination including modifying, using the processing device 1404, the compliance status data using the recomputed rule weight, in accordance with some embodiments.

FIG. 8 illustrates a flowchart of a method 800 of facilitating automated regulatory compliance determination including applying, using the processing device 1404, the industry-specific compliance model during generation of the compliance output data, in accordance with some embodiments.

FIG. 9 illustrates a flowchart of a method 900 of facilitating automated regulatory compliance determination including dynamically adjusting, using the processing device 1404, allocation of a scalable computing resource, in accordance with some embodiments.

FIG. 10 illustrates a flowchart of a method 1000 of facilitating automated regulatory compliance determination including associating, using the processing device 1404, the trace data with the compliance output data, in accordance with some embodiments.

FIG. 11 illustrates a flowchart of a method 1100 of facilitating automated regulatory compliance determination including reducing, using the processing device 1404, computational resource usage while maintaining accuracy of the compliance status data, in accordance with some embodiments.

FIG. 12 illustrates a flowchart of a method 1200 of facilitating automated regulatory compliance determination including preventing, using the processing device 1404, unauthorized modification of the compliance input data during processing, in accordance with some embodiments.

FIG. 13 illustrates a flowchart of a method 1300 of facilitating automated regulatory compliance determination including generating, using the processing device 1404, a standardized regulatory reporting data conforming to the regulatory format definition, in accordance with some embodiments.

FIG. 14 illustrates a block diagram of a system 1400 of facilitating automated regulatory compliance determination, in accordance with some embodiments.

FIG. 15 illustrates a flowchart of a method 1500 of provisioning a neural network, in accordance with some embodiments.

FIG. 16 illustrates a flowchart of a method 1600 of provisioning a neural network including generating, using the processing device 1404, an enterprise output data, in accordance with some embodiments.

FIG. 17 illustrates a flowchart of a method 1700 of provisioning a neural network, in accordance with some embodiments.

FIG. 18 illustrates a flowchart of a method 1800 of provisioning a neural network, in accordance with some embodiments.

FIG. 19 illustrates a flowchart of a method 1900 of provisioning a neural network including receiving, using the communication device 1402, an enterprise sales data from the enterprise data warehouse, in accordance with some embodiments.

FIG. 20 illustrates a flowchart of a method 2000 of provisioning a neural network including receiving, using the communication device 1402, a financial regulatory data from the real time financial regulatory database, in accordance with some embodiments.

FIG. 21 illustrates a flowchart of a method 2100 of provisioning a neural network including determining, using the processing device 1404, a domain indicator, in accordance with some embodiments.

FIG. 22 illustrates a flowchart of a method 2200 of provisioning a neural network including receiving, using the communication device 1402, a training regulatory data from the training regulatory database, in accordance with some embodiments.

FIG. 23 illustrates a flowchart of a method 2300 of provisioning a neural network including receiving, using the communication device 1402, a training allocation data from the enterprise financial database, in accordance with some embodiments.

FIG. 24 illustrates a flowchart of a method 2400 of provisioning a neural network including generating, using the processing device 1404, an automation data, in accordance with some embodiments.

FIG. 25 illustrates a flowchart of a method 2500 of provisioning a neural network including receiving, using the communication device 1402, an enterprise regulatory data from the enterprise regulatory database, in accordance with some embodiments.

FIG. 26 illustrates a flowchart of a method 2600 of provisioning a neural network including receiving, using the processing device 1404, an environment compliance data from the environment regulatory database, in accordance with some embodiments.

FIG. 27 illustrates a flowchart of a method 2700 of provisioning a neural network including allocating, using the processing device 1404, at least one computing service to an enterprise associated with the enterprise input data, in accordance with some embodiments.

FIG. 28 illustrates a flowchart of a method 2800 of provisioning a neural network including managing, using the processing device 1404, the communicating, in accordance with some embodiments.

FIG. 29 illustrates a flowchart of a method 2900 of provisioning a neural network including generating, using the processing device 1404, an anomaly data, in accordance with some embodiments.

FIG. 30 illustrates a flowchart of a method 3000 of provisioning a neural network including generating, using the processing device 1404, an alert data, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and checkpointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols including HTTP, HTTPS, MQTT, CoAP, or any other suitable communication framework. Communication channels may include local networks, wide-area networks, personal-area networks, or global communication systems, potentially utilizing secure encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings therefore provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general purpose central processing units, graphics processing units, digital signal processors, microcontrollers, application specific integrated circuits, field programmable gate arrays, or other programmable or fixed function processing elements configured to execute instructions or perform logic operations. The memory can include volatile and non-volatile storage, such as random access memory and read only memory. The persistent storage can include solid state drives, magnetic disks, optical media, or other non-transitory computer readable media.

Program code executed by the processors can include operating systems, device drivers, libraries, and application programs, including components that implement portions of the methods described herein. Program code and data can be stored on computer readable media and loaded into memory by standard mechanisms, such as boot loaders, installation programs, or update services.

Input devices can include keyboards, pointing devices, microphones, cameras, touch sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi supervised learning, unsupervised learning, reinforcement learning, or combinations thereof. The modeling engine can also manage hyperparameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, LIDAR units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high level goals. These components can generate trajectories or control commands, optionally using reinforcement learned policies, optimization based planners, or hybrid systems. Connections to backend services can permit off board processing, fleet level learning, or remote supervision where appropriate, while on board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre installation, physical distribution of media, or transmission over networks. Instructions received over a network can be stored in memory or persistent storage and then executed by one or more processors. Dedicated hardware logic, such as application specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview

The present invention relates to advanced Artificial Intelligence (AI) platforms, specifically an AI ecosystem that integrates neural network architectures, quantum-inspired cybersecurity, and multi-agent systems to deliver superior performance, automation, and regulatory compliance. This invention further includes the automation of financial governance, ensuring adherence to GAAP and SOX standards, while embedding Industry Training Agents that provide real-time, compliance-driven training based on federal and international standards such as NIST, CISA, OSHA, EPA, and other regulatory bodies across various industries.

Further, the disclosed system addresses the given limitations by combining a quantum-enhanced neural network, multi-agent collaboration, real-time financial compliance, and Industry Training Agents designed to ensure continuous regulatory adherence. The given platform's architecture allows for scalable compliance automation and context-aware business processes, making it a superior AI solution for industries that demand stringent adherence to complex regulatory frameworks.

Further, the disclosed platform is an advanced AI ecosystem that integrates multi-agent systems, neural networks, quantum-enhanced cybersecurity, and financial compliance automation. Designed to ensure regulatory compliance, the platform features Industry Training Agents that provide real-time, context-specific training across multiple industries, ensuring that all users remain up-to-date with compliance best practices.

Further, the present disclosure describes the following key features associated with the disclosed system:
1. Quantum-Enhanced Neural Networks: Blueskys.ai incorporates quantum-inspired algorithms that accelerate learning and optimization within the neural network, allowing for real-time decision-making and processing of complex data streams.
2. Regulatory Compliance and Financial Governance: Blueskys.ai automates compliance with federal and international standards, including GAAP, SOX, NIST, CISA, OSHA, EPA, and other regulatory bodies, ensuring businesses stay compliant across multiple domains.
3. Industry Training Agents: Integrated Industry Training Agents provide continuous, real-time training to users, ensuring they are compliant with evolving regulations and standards across different sectors.
4. Multi-Agent Collaboration: The platform’s AI agents specialize in business automation, predictive analytics, real-time data processing, and natural language processing, collaborating to optimize workflows and decision-making.
5. Quantum Shield Cybersecurity: A quantum-enhanced cybersecurity framework protects data and communications from both classical and future quantum-based attacks, utilizing quantum key distribution (QKD), post-quantum encryption, and anomaly detection.
6. Scalable Cloud Infrastructure: Through Mydigital.dev and Blueskys.AI the platform benefits from dynamic resource scaling, cloud-native data storage, and API management, supporting real-time operations across 200+ applications.

Further, in some embodiments, the present disclosure describes:

1. Quantum-Enhanced Neural Network Architecture

The Blueskys.ai platform incorporates a neural network built on quantum-inspired optimization techniques. These methods allow the system to efficiently process vast amounts of data in real time. The neural network is structured with:

Input Layer: Designed to accept structured and unstructured data, including IoT sensor data, financial reports, user interactions, and regulatory data streams.

Hidden Layers (Quantum Optimization): Proprietary quantum-inspired algorithms are applied to the hidden layers, allowing for rapid optimization of neural connections, ensuring efficient processing with minimal computational overhead.

Output Layer: Produces decisions, alerts, or data visualizations based on real-time analysis across multiple agents.

2. Industry Training Agents

One of the platform's key innovations is its use of Industry Training Agents, which are integrated directly into the neural network and the development pipeline. These agents provide real-time, context-aware training to users, ensuring they remain compliant with relevant regulations.

Dynamic Learning Paths: Industry Training Agents develop personalized learning paths based on user roles, current regulatory requirements, and evolving standards.

Regulatory Updates: These agents deliver instant updates on regulatory changes, ensuring compliance with NIST, OSHA, EPA, CISA, GAAP, SOX, and other frameworks.

Industry-Specific Training: The system tailors training programs to each industry, from environmental compliance (EPA) to corporate governance and financial reporting (GAAP/SOX).

3. Regulatory Compliance and Financial Governance Automation

The disclosed system integrates compliance mechanisms for a range of regulatory bodies, automating processes to meet legal requirements and financial reporting standards. These include:

GAAP (Generally Accepted Accounting Principles): Automated compliance for financial reporting, ensuring accuracy and integrity in financial disclosures.

SOX (Sarbanes-Oxley Act): Compliance automation for corporate governance, internal controls, and financial oversight, ensuring audit readiness and internal accountability.

OSHA and EPA Compliance: Automated workplace safety monitoring and environmental regulation adherence, reducing compliance risks in real time.

NIST and CISA: Continuous monitoring of cybersecurity standards, ensuring businesses follow federal guidelines on risk management and data security

4. Multi-Agent Collaboration

The platform’s multi-agent system allows for parallel processing of complex workflows, driven by specialized agents:

Alice AI 2.0: Manages natural language processing, enabling users to interact with the platform using conversational queries.

Anderson AI: Focuses on business process automation, dynamically adjusting workflows to meet SOX, GAAP, and other compliance standards.

Scream AI: Handles high-performance computing, offering low-latency processing for industries requiring real-time data handling (e.g., finance, infrastructure monitoring).

Katrina AI 2.0: Provides predictive analytics for compliance risk management and financial forecasting

The given agents work together within the platform’s neural network to ensure streamlined decision-making and compliance enforcement.

5. Quantum Shield Cybersecurity

Blueskys.ai employs the Quantum Shield, a quantum-enhanced cybersecurity layer that ensures data integrity and communication security. Key components include:

Quantum Key Distribution (QKD): Protects communications through quantum-based key exchanges, ensuring secure encryption against eavesdropping.

Post-Quantum Encryption: Proprietary encryption techniques designed to withstand future quantum computing attacks.

Real-Time Anomaly Detection: Monitors system activity, detecting security breaches or data anomalies in real time and generating alerts for immediate action.

6. Scalability and Cloud Integration

The disclosed platform benefits from cloud-native infrastructure that supports real-time scalability:

Dynamic Scaling: Resources are allocated automatically based on system demand, ensuring the platform can handle large datasets or increased user traffic without degradation in performance.

API Management: Provides seamless integration with external systems, allowing businesses to connect Blueskys.AI with existing infrastructure.

7. Compliance-Driven Applications

Blueskys.ai features over 200 applications specifically designed for compliance and governance automation. These applications cover a range of industries, providing:

Financial Reporting and Governance (GAAP/SOX): Tools for generating accurate financial reports, auditing internal controls, and ensuring corporate compliance.

Environmental Compliance (EPA): Automated monitoring and reporting of environmental impact, emissions, and waste management.

Workplace Safety (OSHA): Real-time tracking and reporting of workplace safety incidents, ensuring adherence to safety regulations.

Further the present disclosure describes the following exemplary embodiments of the disclosed system:
1. A platform comprising a neural network that integrates quantum-inspired optimization algorithms, ensuring real-time decision-making and compliance automation across multiple domains.
2. A multi-agent system with specialized agents for natural language processing, business automation, predictive analytics, and high-performance computing, designed to enforce regulatory compliance and optimize business workflows.
3. A system for ensuring continuous compliance with GAAP, SOX, NIST, CISA, OSHA, and EPA standards, integrated into the platform’s neural network and business automation processes.
4. A system that integrates Industry Training Agents to provide real-time, context-aware training for users based on evolving regulatory standards and industry best practices.
5. A quantum-enhanced cybersecurity layer (Quantum Shield) employing quantum key distribution, post-quantum encryption, and real-time anomaly detection to secure data and communications within the platform while providing real time reporting.

Further, the disclosed system represents a breakthrough in the AI industry by combining regulatory compliance, financial governance, and industry-specific training into a quantum-enhanced AI ecosystem. Through its multi-agent system, real-time compliance automation, and highly advanced cybersecurity, Blueskys.AI enables businesses to automate and operate more efficiently, securely, and in full adherence to federal and international regulations.

Further, the present disclosure describes the following advantageous aspects associated with the disclosed system:

1. Quantum-Enhanced Neural Networks

The disclosed platform incorporates quantum-inspired algorithms within its neural network architecture, allowing it to leverage quantum principles to optimize learning, data processing, and decision-making.

The given neural network architecture enables faster learning, improved optimization efficiency, and the ability to process and analyze complex, real-time data much more quickly and efficiently than conventional AI systems. Competing AI platforms generally use classical neural networks that may suffer from scaling and computational limits as data volume increases.

2. Multi-Agent Collaboration System

The disclosed system features a multi-agent system where each agent specializes in different functions Alice AI 2.0 for natural language processing, Anderson AI for business automation, Scream AI for high-performance computations, and Katrina AI 2.0 for predictive analytics.

The given multi-agent approach enables parallel task execution and specialization in real-time environments. Instead of relying on a single AI system to handle all functions, Blueskys.ai dynamically allocates tasks to the most relevant agent, enhancing speed, efficiency, and performance across various domains. Other AI platforms typically do not offer such a specialized, collaborative architecture.

3. Quantum Shield Cybersecurity

The disclosed system integrates quantum-enhanced cybersecurity through its proprietary Quantum Shield, which employs quantum key distribution (QKD), post-quantum encryption, and real-time anomaly detection to protect data and communication within the platform. Quantum Shield reports in real-time the detected attacks, the types of attacks, the nature of mitigation response and final disposition after mitigation.

Further, in an era where quantum computing will render many classical encryption methods obsolete, disclosed platform’s post-quantum cryptography offers unparalleled security, ensuring that sensitive data remains protected even against future quantum-based cyberattacks. This level of protection is rare or absent in most AI platforms today, positioning Blueskys.ai as a leader in cybersecurity.

4. Real-Time Data Processing & Visualization

The disclosed platform offers real-time data processing and visualization through its proprietary Quantum Visualizer, converting complex, raw data streams into meaningful, interactive dashboards and visual insights.

The platform is capable of handling high-velocity data from diverse sources, such as IoT devices, financial markets, and supply chains, and transforming them into actionable visual insights in real time. This is critical for industries like finance, healthcare, and infrastructure monitoring, where decisions need to be made instantly. Many other platforms are either focused on batch processing or slower, on-demand querying rather than real-time data updates.

5. Scalability with Cloud Integration

The disclosed system is integrated with Mydigital.dev, providing a cloud-native infrastructure that enables dynamic scalability, on-demand resource allocation, and real-time API management.

As businesses grow, the platform’s scalable architecture can handle massive amounts of data and complex processes without requiring manual intervention. Competing AI platforms often struggle with large-scale real-time data processing without performance degradation, making the disclosed platform’s cloud-based flexibility a key differentiator in the enterprise market.

6. Business Process Automation

The disclosed system uses its Anderson AI to automate and optimize complex business workflows such as resource scheduling, logistics management, and process automation.

The given capability allows businesses to automate time-consuming, repetitive tasks while dynamically optimizing processes based on real-time data. While many AI platforms offer automation, the disclosed platform, with Quantum Enhanced Algorithms, provides smart, context-aware automation that continuously learns and improves over time, making it particularly suited for industries with highly dynamic environments (e.g., manufacturing, retail, logistics).

7. Predictive Analytics & Forecasting

Katrina AI 2.0 is the platform’s agent responsible for predictive analytics and trend forecasting. using advanced machine learning models to identify patterns, predict trends, and offer data-driven recommendations.

The platform’s ability to forecast trends in finance, retail, logistics, and healthcare far exceeds that of many competitors. Katrina AI 2.0 not only analyzes historical data but also adapts its models in real time, making it highly responsive to changing market conditions and real-world events. Traditional AI platforms typically offer predictive analytics but do not feature self-updating models optimized with real-time inputs.

8. Low Latency, High-Performance Computing

The disclosed platform incorporates Scream AI, a high-performance computing agent optimized for low-latency tasks and real-time decision-making in fields requiring fast data processing, such as high-frequency trading or real-time monitoring.

The ability to deliver real-time results at low latency gives Blueskys.ai a significant edge over platforms that rely on batch processing or have slower response times. Its design ensures that industries needing rapid data processing (e.g., financial services, emergency response, infrastructure monitoring) can operate efficiently without delays, a critical advantage over other AI systems that focus only on static data processing.

9. Cross-Industry Application Support

The disclosed platform is built to support over 200 applications across various sectors, including environmental, industrial, e-commerce, financial services, and business intelligence.

Many AI platforms are niche-specific and are designed for particular industries or use cases. Blueskys.AI offers a platform capable of adapting to multiple industries by dynamically deploying specialized AI agents for different tasks, making it a highly versatile solution. Whether it's predicting environmental changes, automating supply chains, or enhancing customer engagement, the platform’s versatility is a standout feature.

10. Proprietary Quantum-Inspired Optimization Algorithms

The platform utilizes proprietary quantum-inspired algorithms to optimize its neural network, business workflows, and data processing in real time. These algorithms ensure that Blueskys.AI performs tasks with minimal resource consumption and maximum efficiency.

The said aspect gives the disclosed platform the ability to optimize computational performance dynamically based on the workload, a key feature for businesses looking to lower operational costs without sacrificing performance. Other AI platforms rely on classical optimization methods, which often require manual intervention to achieve the same level of resource efficiency.

Further, the disclosed platform stands out for its quantum-inspired innovations, multi-agent collaboration, and benchmark cybersecurity, all of which provide numerous opportunities for patenting distinct technical advancements. Unlike other AI platforms, the disclosed platform uses
1. Quantum-inspired neural networks and optimization.
2. Multi-agent architecture.
3. Quantum Shield: autonomous cybersecurity protections, mitigation and reporting.
4. Cybersecurity measures incorporated in all digital assets and applications.
5. Real-time data handling and adaptive processing.
6. Scalability across multiple industries.

Further, the said aspects make the disclosed system a patentable innovation that leads the industry in terms of both technology and applicability. The said features may be framed in a way that highlights their novelty and non-obviousness, two key criteria for patentability.

Further, the disclosed system excels in multi-agent collaboration, quantum-enhanced security and reporting, real-time processing, and dynamic scalability, making it a next-generation AI platform designed to handle complex and evolving business needs. Compared to conventional AI platforms, the disclosed platform’s quantum-inspired architecture, business automation, and industry versatility place it at the forefront of the AI landscape.

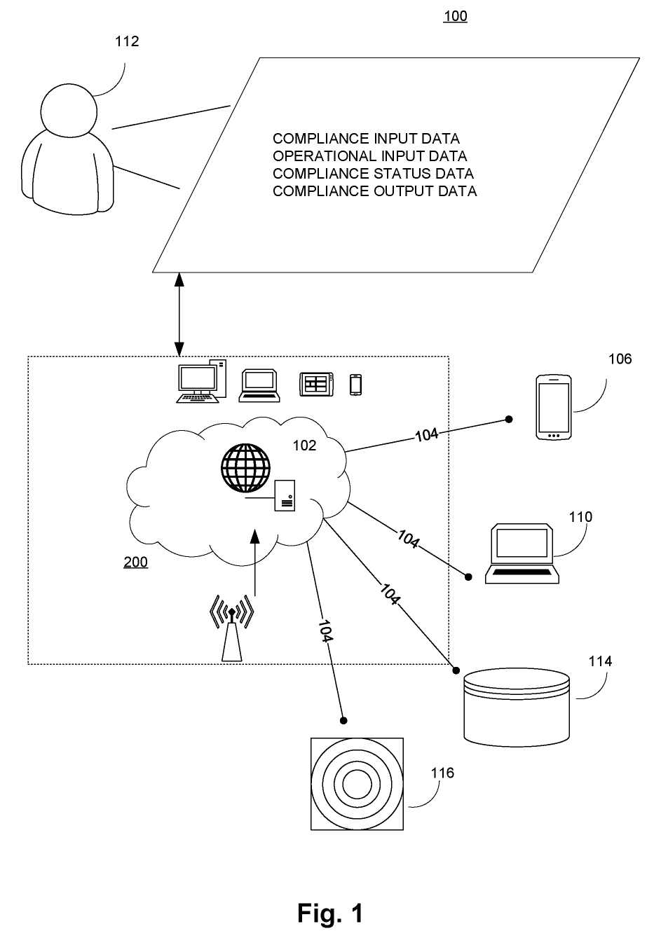

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

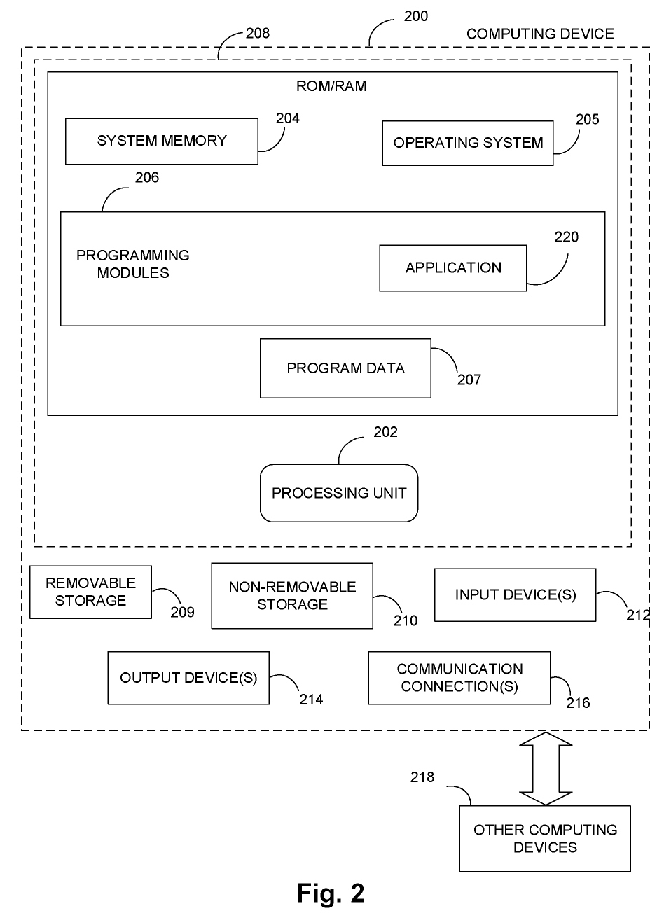

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

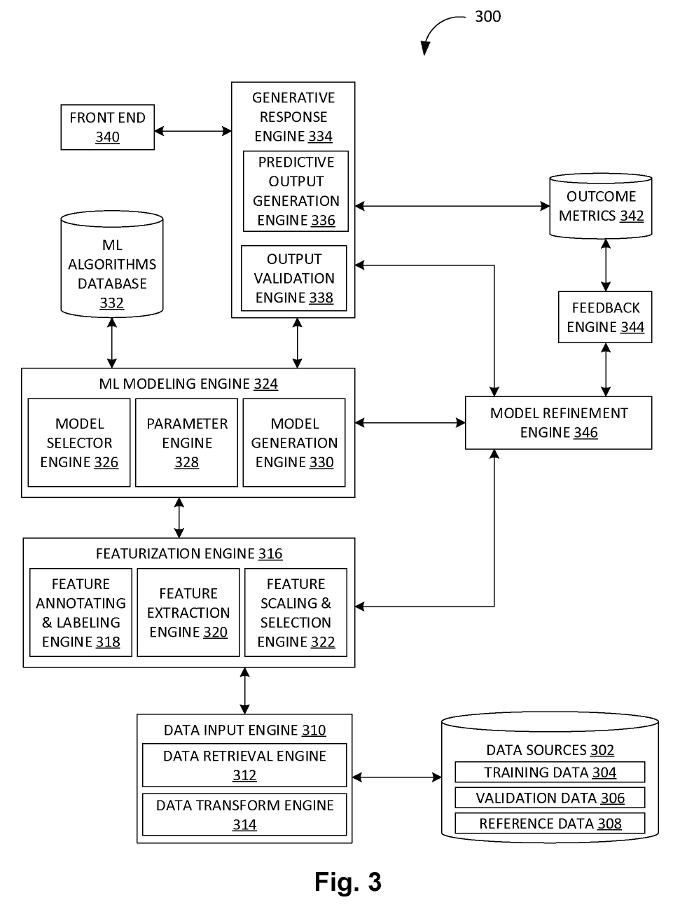

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For, example some components that are illustrated as separate, may be combined with other components and some components may be divided into separate components.

Accordingly, the machine-learning system 300 may include a plurality of interrelated modules and engines configured to implement a machine‑learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the data input engine 310 may be implemented on a computing device.

Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the featurization engine 316 may be implemented on the computing device.

Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyper parameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the ML modeling engine 324 may be implemented on the computing device.

Further, the machine-learning system 300 may include a generative response engine 334 configured to produce user‑facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the generative response engine 334 may be implemented on the computing device.

Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and the feedback engine 344 provide closed‑loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine‑learning system 300. Further, the feedback engine 344 may be implemented on the computing device.

Any or each engine of the machine-learning system 300 may be and/or may include a module (e.g., a program module), which may be a hardware unit configured to be used with other components or a part of a program that performs a particular function. Further, any or each engine of the machine-learning system 300 may be implemented using a computing device.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

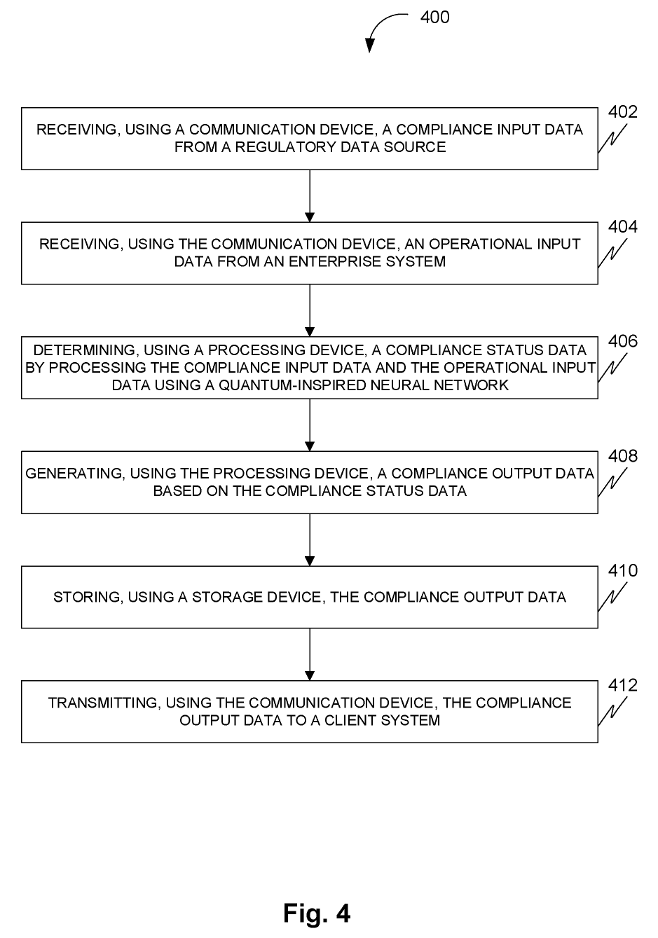

FIG. 4 illustrates a flowchart of a method 400 of facilitating automated regulatory compliance determination, in accordance with some embodiments. Accordingly, the method 400 may include a step 402 of receiving, using a communication device 1402, a compliance input data from a regulatory data source. Further, the method 400 may include a step 404 of receiving, using the communication device 1402, an operational input data from an enterprise system. Further, the method 400 may include a step 406 of determining, using a processing device 1404, a compliance status data by processing the compliance input data and the operational input data using a quantum-inspired neural network. Further, the method 400 may include a step 408 of generating, using the processing device 1404, a compliance output data based on the compliance status data. Further, the method 400 may include a step 410 of storing, using a storage device 1406, the compliance output data. Further, the method 400 may include a step 412 of transmitting, using the communication device 1402, the compliance output data to a client system.

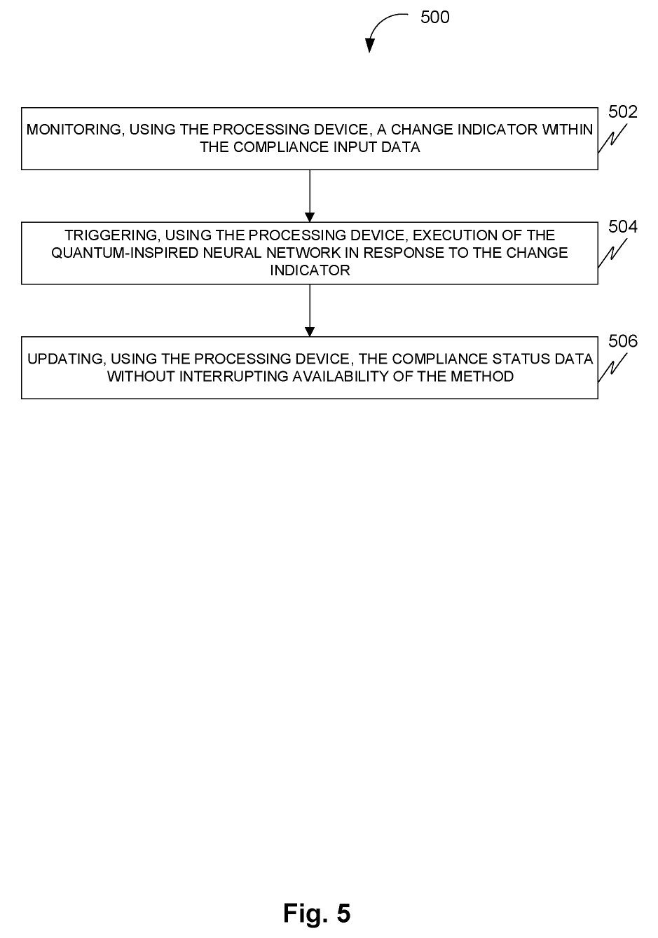

FIG. 5 illustrates a flowchart of a method 500 of facilitating automated regulatory compliance determination including updating, using the processing device 1404, the compliance status data without interrupting availability of the method, in accordance with some embodiments. Further, in some embodiments, the method 500, further may include a step 502 of monitoring, using the processing device 1404, a change indicator within the compliance input data. Further, in some embodiments, the method 500, further may include a step 504 of triggering, using the processing device 1404, execution of the quantum-inspired neural network in response to the change indicator. Further, in some embodiments, the method 500, further may include a step 506 of updating, using the processing device 1404, the compliance status data without interrupting availability of the method 500.

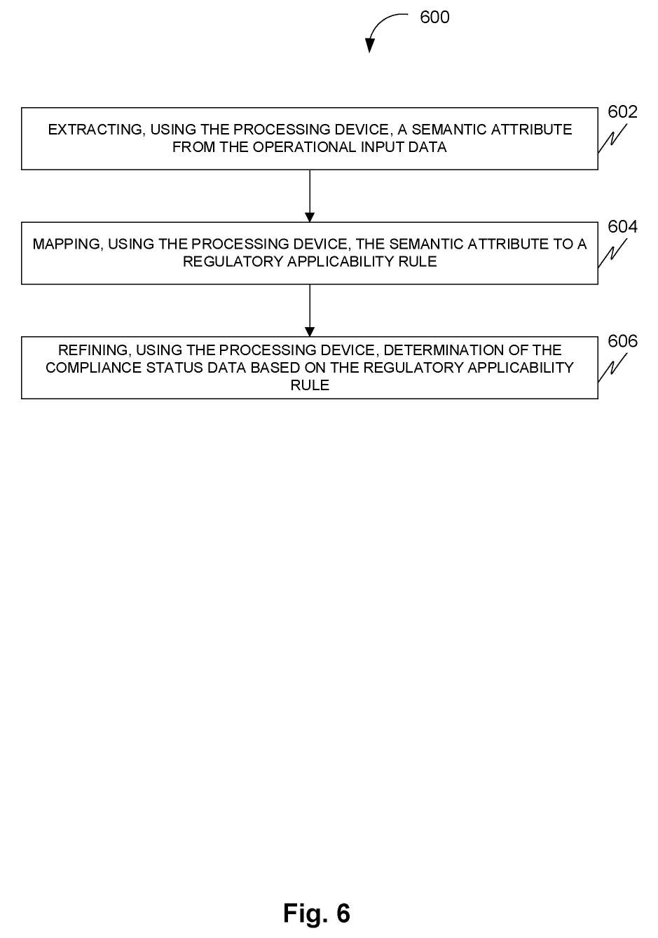

FIG. 6 illustrates a flowchart of a method 600 of facilitating automated regulatory compliance determination including refining, using the processing device 1404, determination of the compliance status data, in accordance with some embodiments. Further, in some embodiments, the method 600, further may include a step 602 of extracting, using the processing device 1404, a semantic attribute from the operational input data. Further, in some embodiments, the method 600, further may include a step 604 of mapping, using the processing device 1404, the semantic attribute to a regulatory applicability rule. Further, in some embodiments, the method 600, further may include a step 606 of refining, using the processing device 1404, determination of the compliance status data based on the regulatory applicability rule.

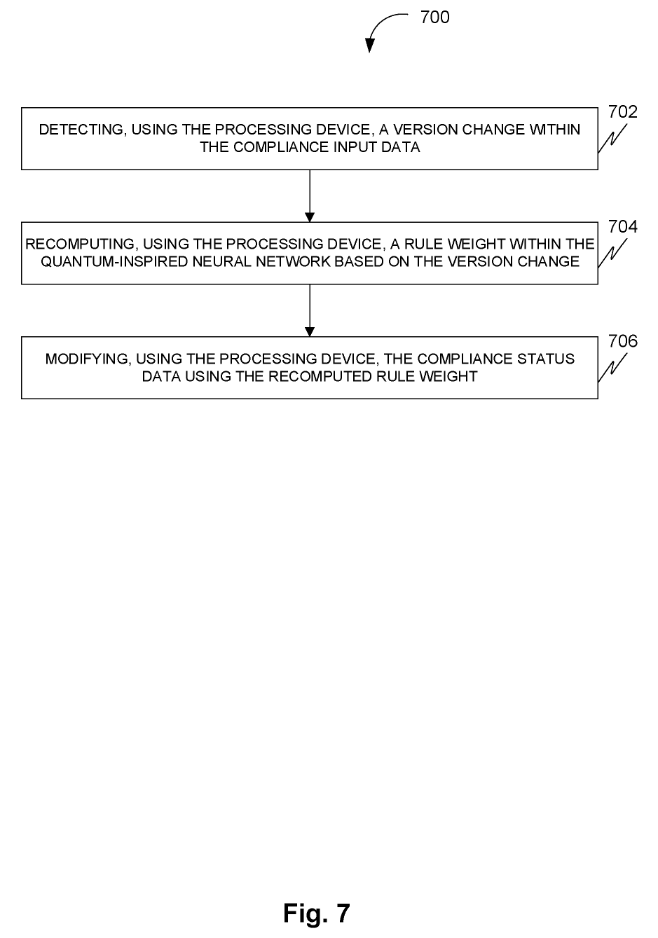

FIG. 7 illustrates a flowchart of a method 700 of facilitating automated regulatory compliance determination including modifying, using the processing device 1404, the compliance status data using the recomputed rule weight, in accordance with some embodiments. Further, in some embodiments, the method 700, further may include a step 702 of detecting, using the processing device 1404, a version change within the compliance input data. Further, in some embodiments, the method 700, further may include a step 704 of recomputing, using the processing device 1404, a rule weight within the quantum-inspired neural network based on the version change. Further, in some embodiments, the method 700, further may include a step 706 of modifying, using the processing device 1404, the compliance status data using the recomputed rule weight.

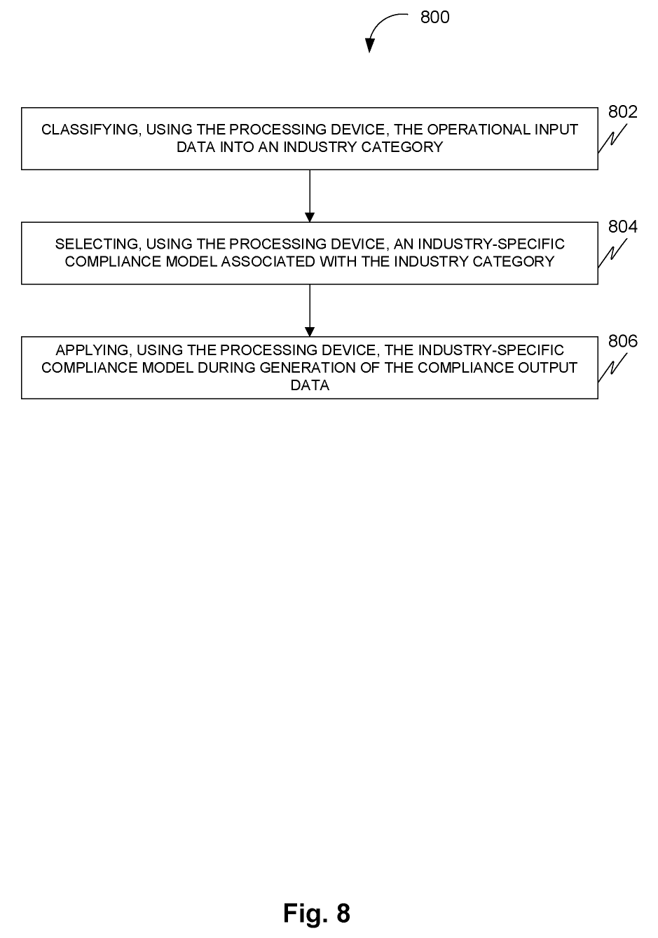

FIG. 8 illustrates a flowchart of a method 800 of facilitating automated regulatory compliance determination including applying, using the processing device 1404, the industry-specific compliance model during generation of the compliance output data, in accordance with some embodiments. Further, in some embodiments, the method 800, further may include a step 802 of classifying, using the processing device 1404, the operational input data into an industry category. Further, in some embodiments, the method 800, further may include a step 804 of selecting, using the processing device 1404, an industry-specific compliance model associated with the industry category. Further, in some embodiments, the method 800, further may include a step 806 of applying, using the processing device 1404, the industry-specific compliance model during generation of the compliance output data.

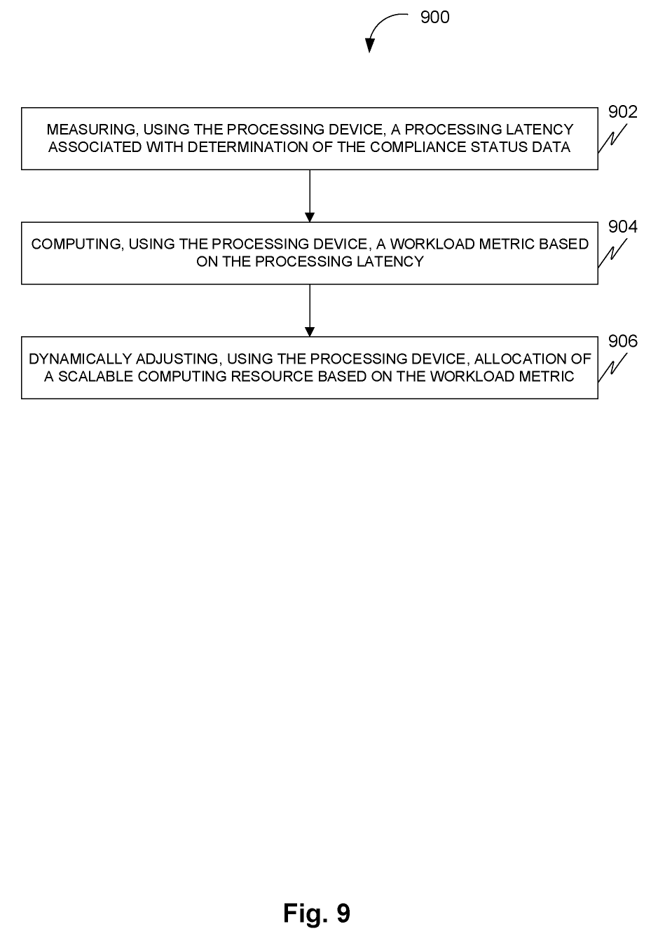

FIG. 9 illustrates a flowchart of a method 900 of facilitating automated regulatory compliance determination including dynamically adjusting, using the processing device 1404, allocation of a scalable computing resource, in accordance with some embodiments. Further, in some embodiments, the method 900, further may include a step 902 of measuring, using the processing device 1404, a processing latency associated with determination of the compliance status data. Further, in some embodiments, the method 900, further may include a step 904 of computing, using the processing device 1404, a workload metric based on the processing latency. Further, in some embodiments, the method 900, further may include a step 906 of dynamically adjusting, using the processing device 1404, allocation of a scalable computing resource based on the workload metric.

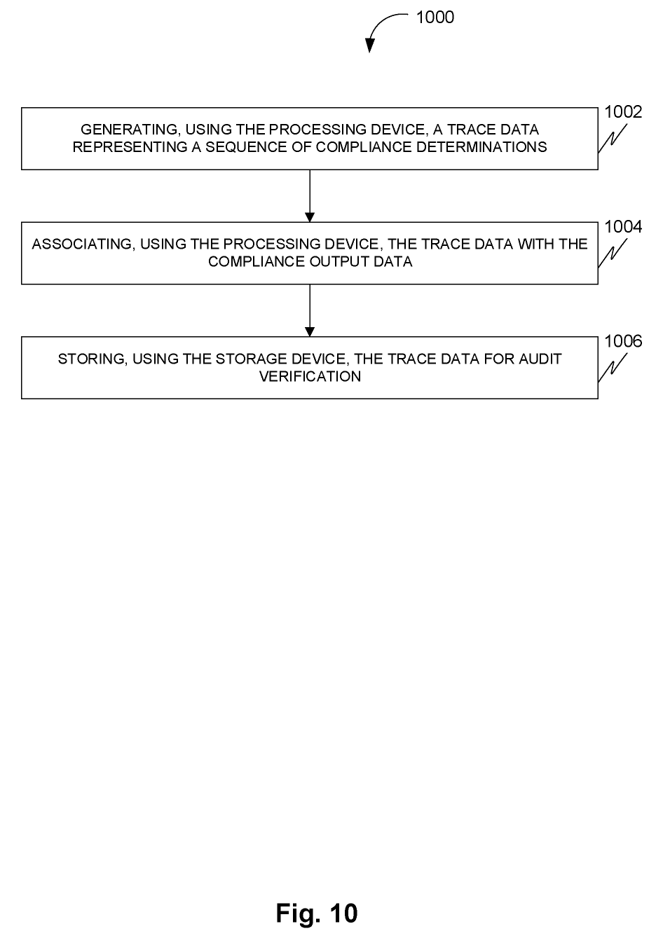

FIG. 10 illustrates a flowchart of a method 1000 of facilitating automated regulatory compliance determination including associating, using the processing device 1404, the trace data with the compliance output data, in accordance with some embodiments. Further, in some embodiments, the method 1000, further may include a step 1002 of generating, using the processing device 1404, a trace data representing a sequence of compliance determinations. Further, in some embodiments, the method 1000, further may include a step 1004 of associating, using the processing device 1404, the trace data with the compliance output data. Further, in some embodiments, the method 1000, further may include a step 1006 of storing, using the storage device 1406, the trace data for audit verification.

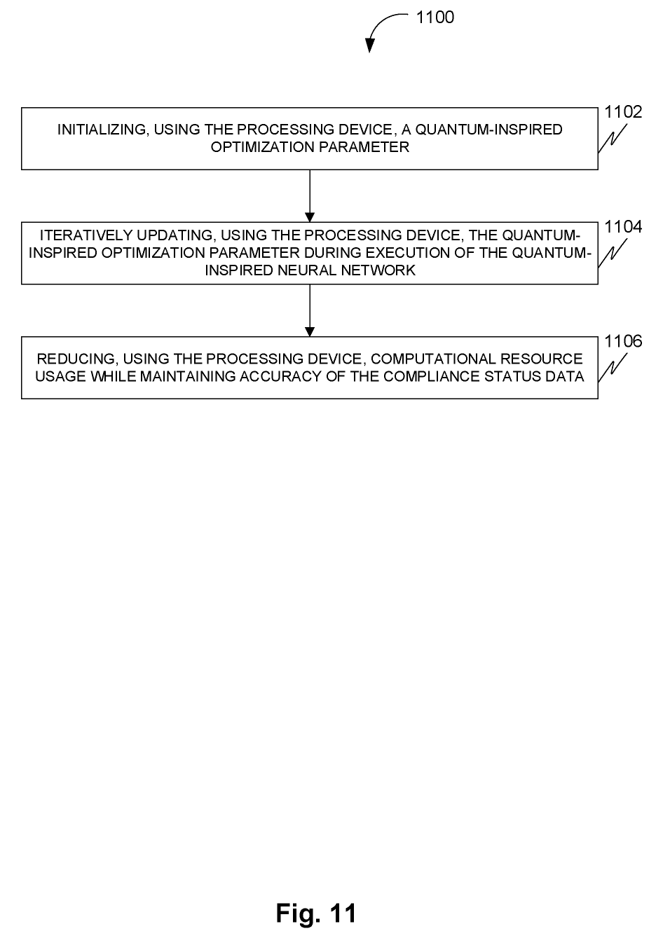

FIG. 11 illustrates a flowchart of a method 1100 of facilitating automated regulatory compliance determination including reducing, using the processing device 1404, computational resource usage while maintaining accuracy of the compliance status data, in accordance with some embodiments. Further, in some embodiments, the method 1100, further may include a step 1102 of initializing, using the processing device 1404, a quantum-inspired optimization parameter. Further, in some embodiments, the method 1100, further may include a step 1104 of iteratively updating, using the processing device 1404, the quantum-inspired optimization parameter during execution of the quantum-inspired neural network. Further, in some embodiments, the method 1100, further may include a step 1106 of reducing, using the processing device 1404, computational resource usage while maintaining accuracy of the compliance status data.

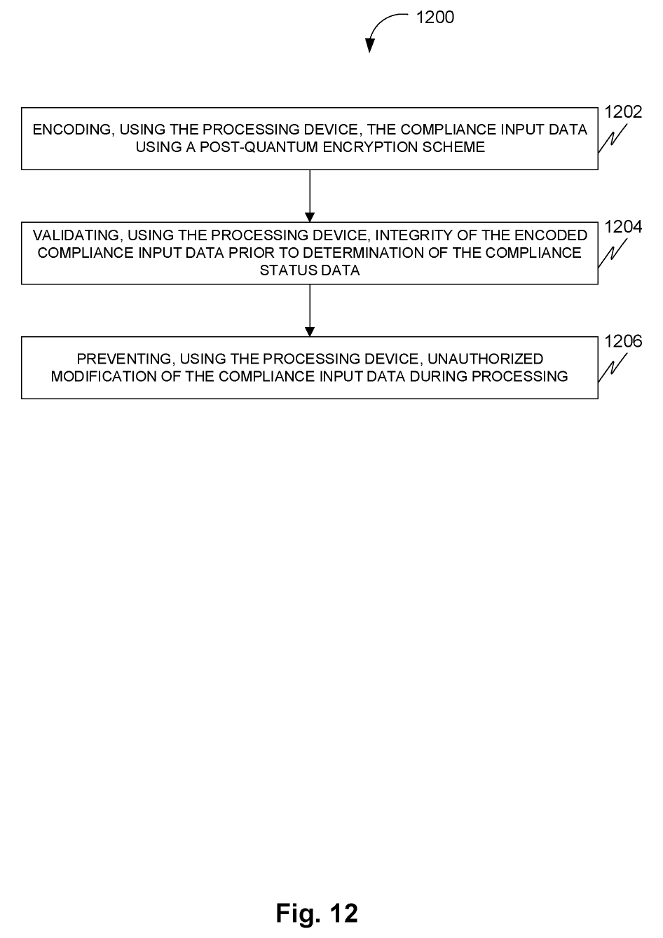

FIG. 12 illustrates a flowchart of a method 1200 of facilitating automated regulatory compliance determination including preventing, using the processing device 1404, unauthorized modification of the compliance input data during processing, in accordance with some embodiments. Further, in some embodiments, the method 1200, further may include a step 1202 of encoding, using the processing device 1404, the compliance input data using a post-quantum encryption scheme. Further, in some embodiments, the method 1200, further may include a step 1204 of validating, using the processing device 1404, integrity of the encoded compliance input data prior to determination of the compliance status data. Further, in some embodiments, the method 1200, further may include a step 1206 of preventing, using the processing device 1404, unauthorized modification of the compliance input data during processing.

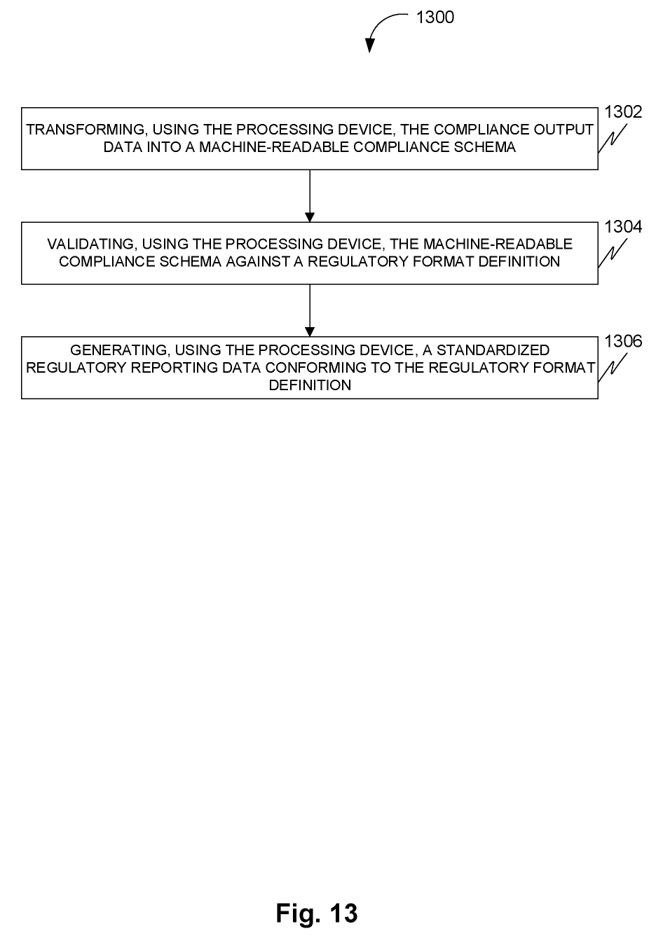

FIG. 13 illustrates a flowchart of a method 1300 of facilitating automated regulatory compliance determination including generating, using the processing device 1404, a standardized regulatory reporting data conforming to the regulatory format definition, in accordance with some embodiments. Further, in some embodiments, the method 1300, further may include a step 1302 of transforming, using the processing device 1404, the compliance output data into a machine-readable compliance schema. Further, in some embodiments, the method 1300, further may include a step 1304 of validating, using the processing device 1404, the machine-readable compliance schema against a regulatory format definition. Further, in some embodiments, the method 1300, further may include a step 1306 of generating, using the processing device 1404, a standardized regulatory reporting data conforming to the regulatory format definition.

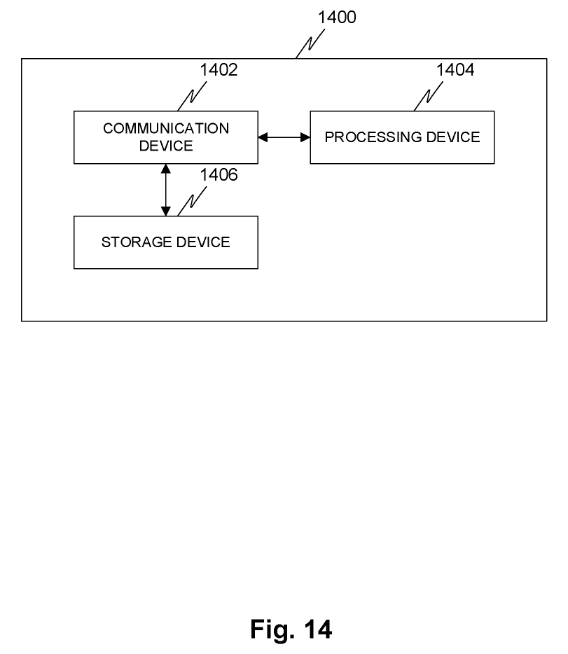

FIG. 14 illustrates a block diagram of a system 1400 of facilitating automated regulatory compliance determination, in accordance with some embodiments. Accordingly, the system 1400 may include a communication device 1402. Further, the communication device 1402 may be configured for receiving a compliance input data from a regulatory data source. Further, the communication device 1402 may be configured for receiving an operational input data from an enterprise system. Further, the communication device 1402 may be configured for transmitting a compliance output data to a client system. Further, the system 1400 may include a processing device 1404 communicatively coupled with the communication device 1402. Further, the processing device 1404 may be configured for determining a compliance status data by processing the compliance input data and the operational input data using a quantum-inspired neural network. Further, the processing device 1404 may be configured for generating the compliance output data based on the compliance status data. Further, the system 1400 may include a storage device 1406 communicatively coupled with the processing device 1404, Further, the storage device 1406 may be configured for storing the compliance output data.

Further, in some embodiments, the processing device 1404 may be further configured for monitoring a change indicator within the compliance input data. Further, the processing device 1404 may be further configured for triggering execution of the quantum-inspired neural network in response to the change indicator. Further, the processing device 1404 may be further configured for updating the compliance status data without interrupting system availability.

Further, in some embodiments, the processing device 1404 may be further configured for extracting a semantic attribute from the operational input data. Further, the processing device 1404 may be further configured for mapping the semantic attribute to a regulatory applicability rule. Further, the processing device 1404 may be further configured for refining determination of the compliance status data based on the regulatory applicability rule.

Further, in some embodiments, the processing device 1404 may be further configured for detecting a version change within the compliance input data. Further, the processing device 1404 may be further configured for recomputing a rule weight within the quantum-inspired neural network based on the version change. Further, the processing device 1404 may be further configured for modifying the compliance status data using the recomputed rule weight.

Further, in some embodiments, the processing device 1404 may be further configured for classifying the operational input data into an industry category. Further, the processing device 1404 may be further configured for selecting an industry-specific compliance model associated with the industry category. Further, the processing device 1404 may be further configured for applying the industry-specific compliance model during generation of the compliance output data.

Further, in some embodiments, the processing device 1404 may be further configured for measuring a processing latency associated with determination of the compliance status data. Further, the processing device 1404 may be further configured for computing a workload metric based on the processing latency. Further, the processing device 1404 may be further configured for dynamically adjusting allocation of a scalable computing resource based on the workload metric.

Further, in some embodiments, the processing device 1404 may be further configured for generating a trace data representing a sequence of compliance determinations. Further, the processing device 1404 may be further configured for associating the trace data with the compliance output data. Further, the storage device 1406 may be further configured for storing the trace data for audit verification.

Further, in some embodiments, the processing device 1404 may be further configured for initializing a quantum-inspired optimization parameter. Further, the processing device 1404 may be further configured for iteratively updating the quantum-inspired optimization parameter during execution of the quantum-inspired neural network. Further, the processing device 1404 may be further configured for reducing computational resource usage while maintaining accuracy of the compliance status data.

Further, in some embodiments, the processing device 1404 may be further configured for encoding the compliance input data using a post-quantum encryption scheme. Further, the processing device 1404 may be further configured for validating integrity of the encoded compliance input data prior to determination of the compliance status data. Further, the processing device 1404 may be further configured for preventing unauthorized modification of the compliance input data during processing.

Further, in some embodiments, the processing device 1404 may be further configured for transforming the compliance output data into a machine-readable compliance schema. Further, the processing device 1404 may be further configured for validating the machine-readable compliance schema against a regulatory format definition. Further, the processing device 1404 may be further configured for generating a standardized regulatory reporting data conforming to the regulatory format definition.

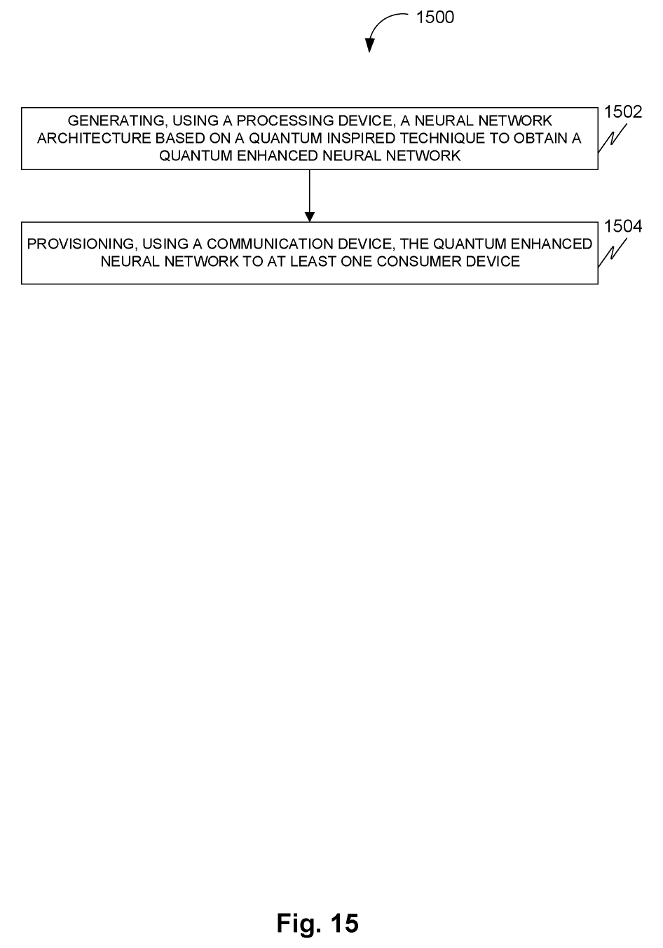

FIG. 15 illustrates a flowchart of a method 1500 of provisioning a neural network, in accordance with some embodiments. Accordingly, the method 1500 may include a step 1502 of generating, using a processing device 1404, a neural network architecture based on a quantum inspired technique to obtain a quantum enhanced neural network. Further, the method 1500 may include a step 1504 of provisioning, using a communication device 1402, the quantum enhanced neural network to one or more consumer devices.

In some embodiments, the neural network includes one or more of an input layer which may be configured for receiving an input data, one or more of a hidden layer which may be configured for processing the input data, one or more output layers which may be configured for generating an output data based on the processing. Further, the provisioning includes transmitting, using the communication device 1402, the output data to the one or more consumer devices.

In some embodiments, the method 1500 may further include training, using the processing device 1404, the quantum enhanced neural network based on a training data.

In some embodiments, the training data includes a structured data.

In some embodiments, the training data includes an unstructured data.

In some embodiments, the training data includes IoT sensor data.

In some embodiments, the training data includes financial report data.

In some embodiments, the training data includes a user interaction data.

In some embodiments, the training data includes a regulatory data.

In some embodiments, the training may be based on one or more quantum inspired techniques.

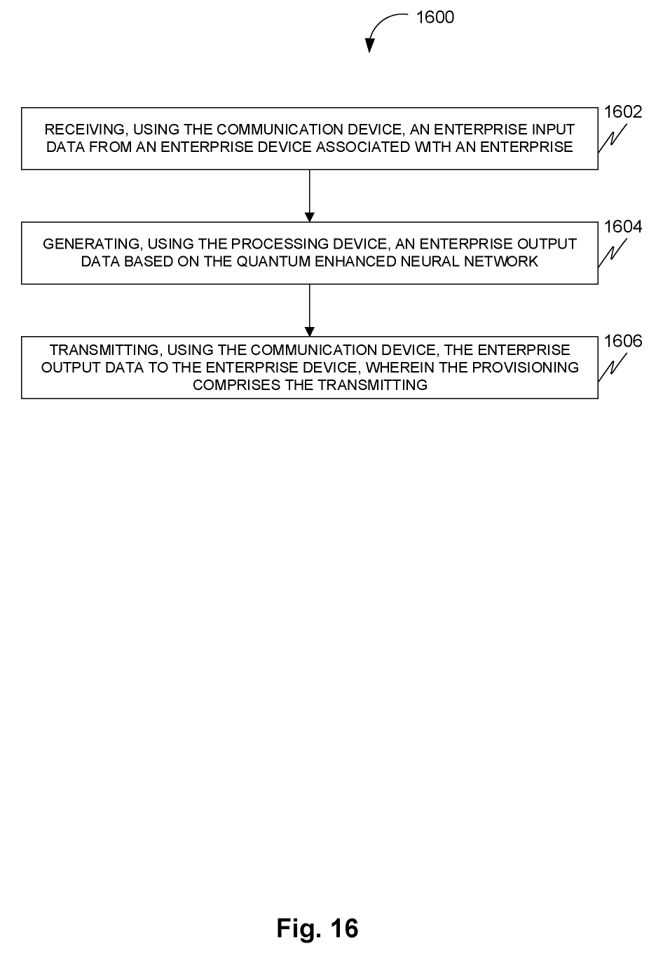

FIG. 16 illustrates a flowchart of a method 1600 of provisioning a neural network including generating, using the processing device 1404, an enterprise output data, in accordance with some embodiments. Further, in some embodiments, the method 1600 further may include a step 1602 of receiving, using the communication device 1402, an enterprise input data from an enterprise device associated with an enterprise. Further, in some embodiments, the method 1600 further may include a step 1604 of generating, using the processing device 1404, an enterprise output data based on the quantum enhanced neural network. Further, in some embodiments, the method 1600 further may include a step 1606 of transmitting, using the communication device 1402, the enterprise output data to the enterprise device. Further, the provisioning includes the transmitting.

In some embodiments, the one or more quantum inspired techniques may be based on one or more principles of quantum mechanics.

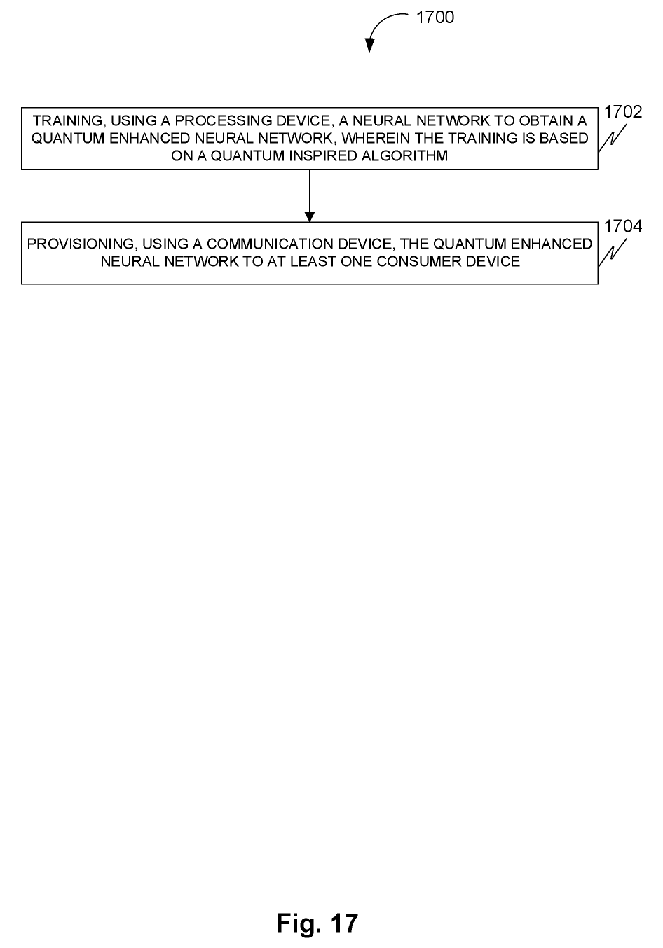

FIG. 17 illustrates a flowchart of a method 1700 of provisioning a neural network, in accordance with some embodiments. Accordingly, the method 1700 may include a step 1702 of training, using a processing device 1404, a neural network to obtain a quantum enhanced neural network. Further, the training may be based on a quantum inspired algorithm. Further, the method 1700 may include a step 1704 of provisioning, using a communication device 1402, the quantum enhanced neural network to one or more consumer devices.

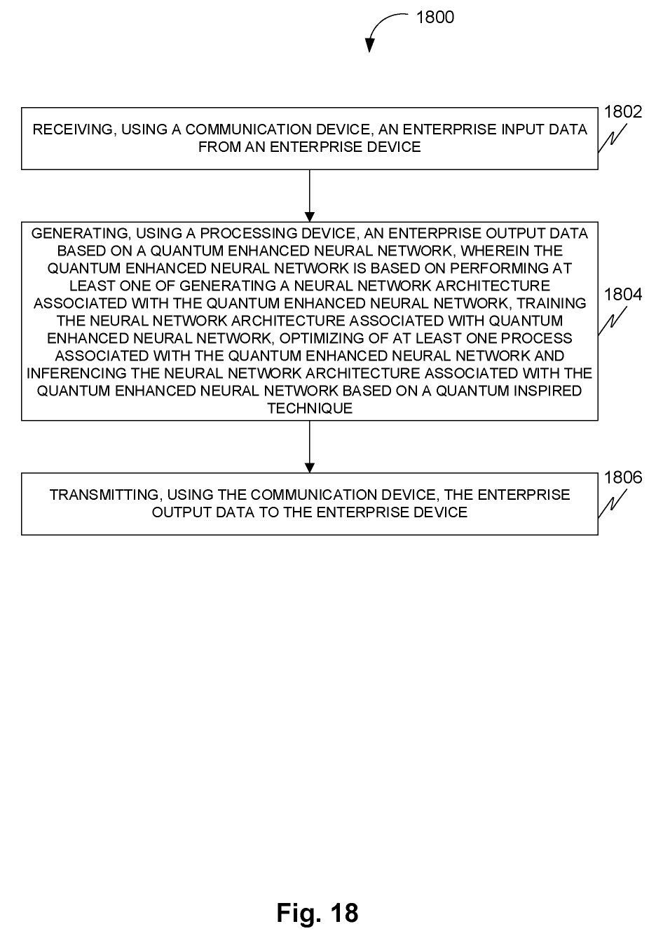

FIG. 18 illustrates a flowchart of a method 1800 of provisioning a neural network, in accordance with some embodiments. Accordingly, the method 1800 may include a step 1802 of receiving, using a communication device 1402, an enterprise input data from an enterprise device. Further, the method 1800 may include a step 1804 of generating, using a processing device 1404, an enterprise output data based on a quantum enhanced neural network. Further, the quantum enhanced neural network may be based on performing one or more of generating a neural network architecture associated with the quantum enhanced neural network, training the neural network architecture associated with quantum enhanced neural network, optimizing of one or more process associated with the quantum enhanced neural network and inferencing the neural network architecture associated with the quantum enhanced neural network based on a quantum inspired technique. Further, the method 1800 may include a step 1806 of transmitting, using the communication device 1402, the enterprise output data to the enterprise device.

In some embodiments, the method 1500 may further include optimizing, using the processing device 1404, the quantum enhanced neural network based on the one or more quantum inspired techniques to obtain an optimized quantum enhanced neural network. Further, the provisioning includes provisioning the optimized quantum enhanced neural network.

In some embodiments, the generating of the enterprise output data may be based on an AI agent module.

In some embodiments, the AI agent module includes two or more AI agent modules.

In some embodiments, the two or more AI agent modules includes a text processing AI agent module which may be configured for performing natural language processing of the enterprise input data.

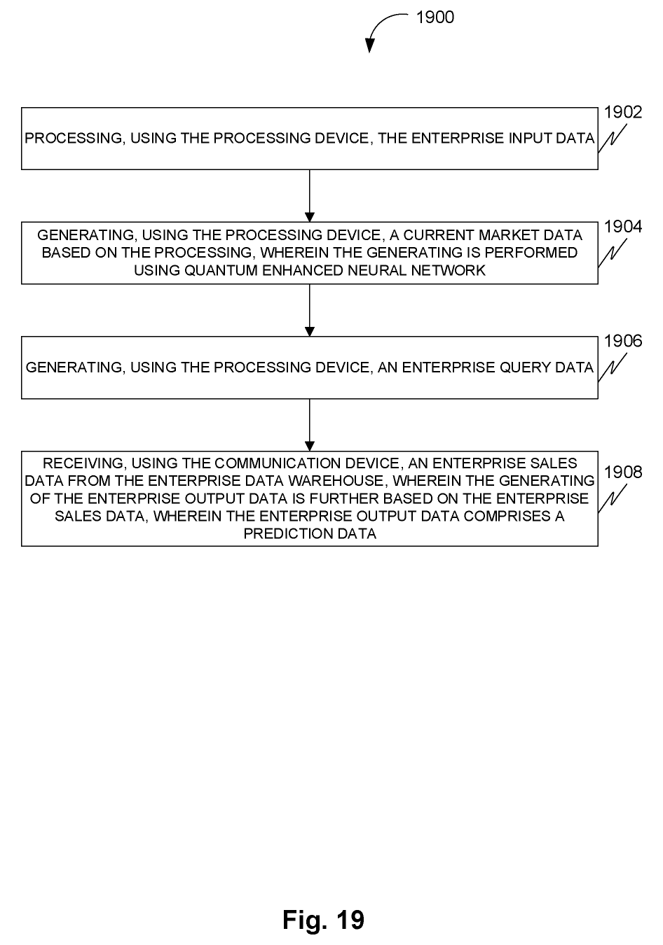

FIG. 19 illustrates a flowchart of a method 1900 of provisioning a neural network including receiving, using the communication device 1402, an enterprise sales data from the enterprise data warehouse, in accordance with some embodiments. Further, in some embodiments, the two or more AI agent modules may include a forecasting AI agent module may be configured for performing predictive analysis, the method 1900 may include a step 1902 of processing, using the processing device 1404, the enterprise input data. Further, the two or more AI agent modules may include a forecasting AI agent module may be configured for performing predictive analysis, the method 1900 may include a step 1904 of generating, using the processing device 1404, a current market data based on the processing. Further, the generating may be performed using quantum enhanced neural network. Further, the two or more AI agent modules may include a forecasting AI agent module may be configured for performing predictive analysis, the method 1900 may include a step 706 of generating, using the processing device 1404, an enterprise query data. Further, the two or more AI agent modules may include a forecasting AI agent module may be configured for performing predictive analysis, the method 1900 may include a step 708 of receiving, using the communication device 1402, an enterprise sales data from the enterprise data warehouse. Further, the generating of the enterprise output data may be further based on the enterprise sales data. Further, the enterprise output data includes a prediction data.

In some embodiments, the two or more AI agent modules includes a data processing AI agent module which may be configured for performing a real-time decision making task based on the enterprise input data.

In some embodiments, the two or more AI agent modules includes a data visualization AI agent module which may be configured for generating a visualization data comprising a dynamic and interactive data visualization. Further, the generating of the enterprise output data includes the visualization data.

In some embodiments, the enterprise input data includes a raw data. Further, the raw data represents unprocessed enterprise input data. Further, the method 1600 further includes processing the unprocessed enterprise input data. Further, the generating of the enterprise output data may be based on the processing.

In some embodiments, the enterprise input data includes a high velocity data.

In some embodiments, the high velocity data includes an IoT device data.

In some embodiments, the high velocity data includes a financial market data.

In some embodiments, the high velocity data includes a supply chain data.

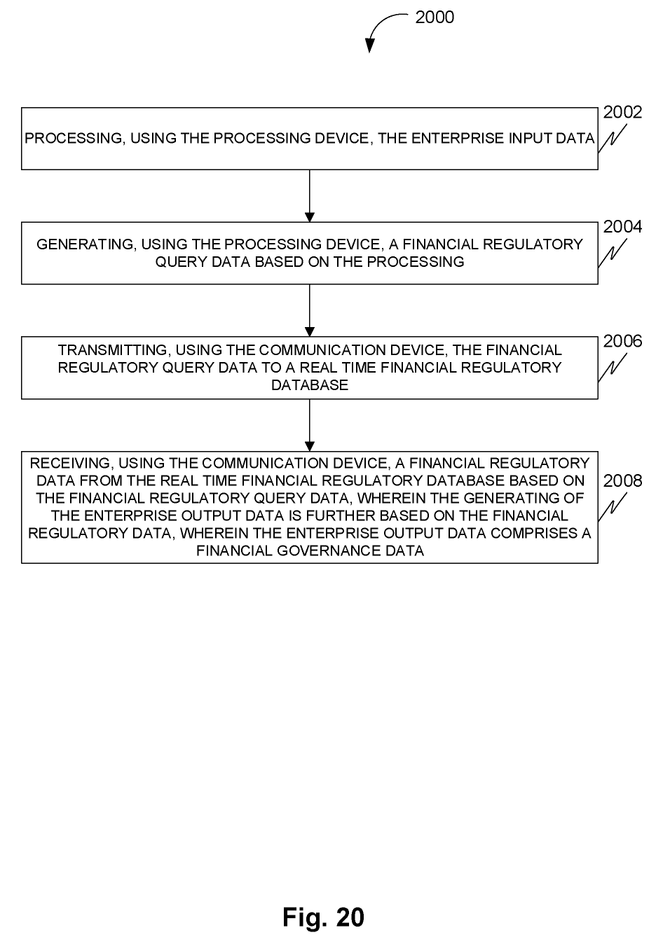

FIG. 20 illustrates a flowchart of a method 2000 of provisioning a neural network including receiving, using the communication device 1402, a financial regulatory data from the real time financial regulatory database, in accordance with some embodiments. Further, in some embodiments, the two or more AI agent modules may include a financial governance AI agent module may be configured for performing real time financial governance, the method 2000 may include a step 2002 of processing, using the processing device 1404, the enterprise input data. Further, the two or more AI agent modules may include a financial governance AI agent module may be configured for performing real time financial governance, the method 2000 may include a step 2004 of generating, using the processing device 1404, a financial regulatory query data based on the processing. Further, the two or more AI agent modules may include a financial governance AI agent module may be configured for performing real time financial governance, the method 2000 may include a step 2006 of transmitting, using the communication device 1402, the financial regulatory query data to a real time financial regulatory database. Further, the two or more AI agent modules may include a financial governance AI agent module may be configured for performing real time financial governance, the method 2000 may include a step 2008 of receiving, using the communication device 1402, a financial regulatory data from the real time financial regulatory database based on the financial regulatory query data. Further, the generating of the enterprise output data may be further based on the financial regulatory data. Further, the enterprise output data includes a financial governance data.

In some embodiments, the financial regulatory data conforms to one or more standards.

In some embodiments, the one or more standards includes Generally Accepted Accounting Principles (GAAP) standard.

In some embodiments, the one or more standards includes Sarbanes-Oxley Act (SOX)standard.

In some embodiments, the financial regulatory data includes a financial regulatory version data indicating a version of the financial regulatory data.

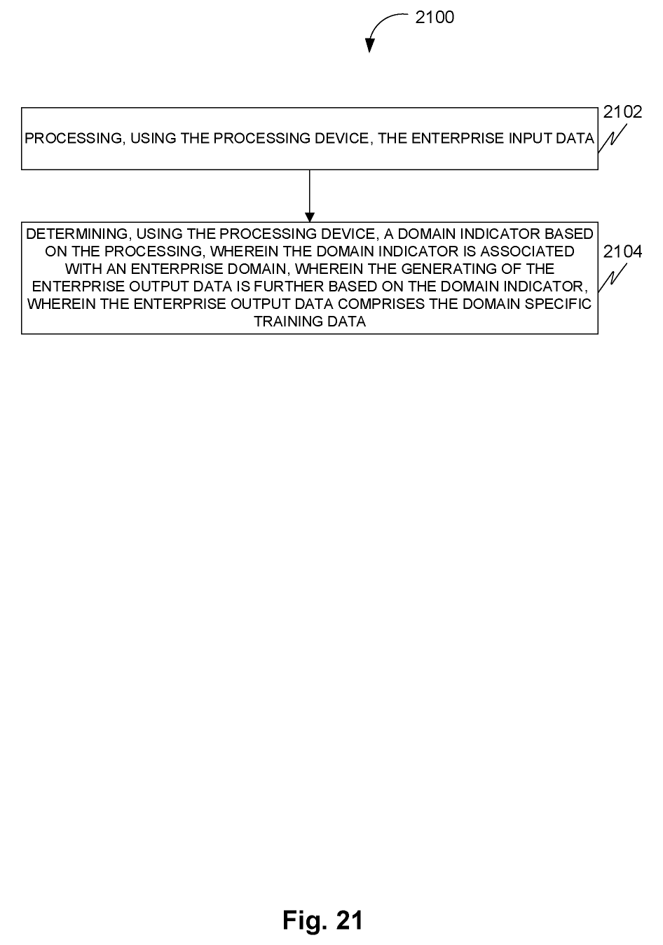

FIG. 21 illustrates a flowchart of a method 2100 of provisioning a neural network including determining, using the processing device 1404, a domain indicator, in accordance with some embodiments. Further, in some embodiments, the two or more AI agent modules may include a training AI agent module may be configured for generating a domain specific training data. Further, the generating further may include a step 2102 of processing, using the processing device 1404, the enterprise input data. Further, the generating further may include a step 2104 of determining, using the processing device 1404, a domain indicator based on the processing. Further, the domain indicator may be associated with an enterprise domain. Further, the generating of the enterprise output data may be further based on the domain indicator. Further, the enterprise output data includes the domain specific training data.

In some embodiments, the enterprise input data includes an enterprise user role data representing a role of a user associated with the enterprise input data.

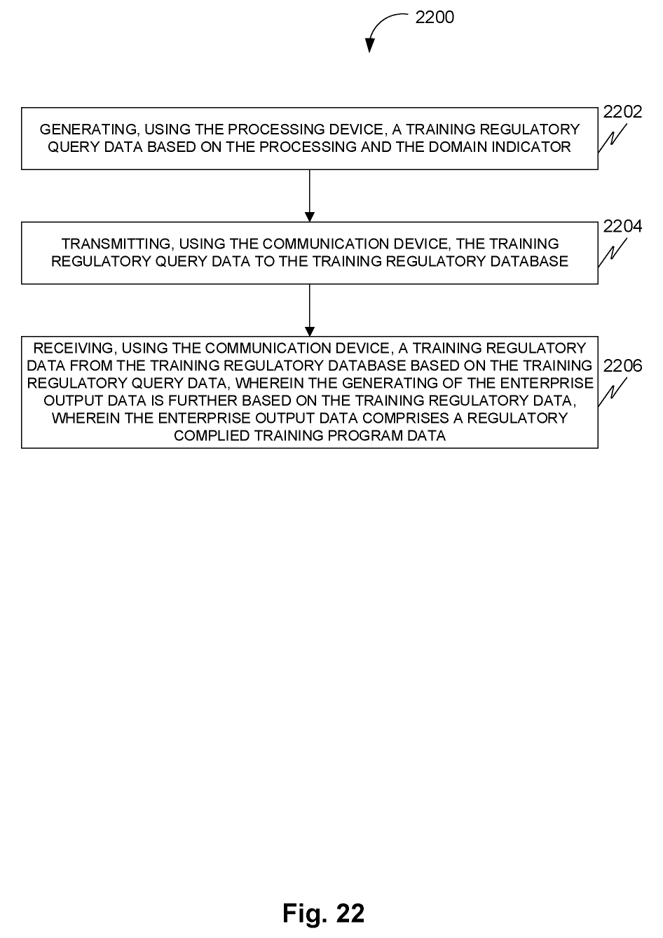

FIG. 22 illustrates a flowchart of a method 2200 of provisioning a neural network including receiving, using the communication device 1402, a training regulatory data from the training regulatory database, in accordance with some embodiments. Further, in some embodiments, the method 2200, further may include a step 2202 of generating, using the processing device 1404, a training regulatory query data based on the processing and the domain indicator. Further, in some embodiments, the method 2200, further may include a step 2204 of transmitting, using the communication device 1402, the training regulatory query data to the training regulatory database. Further, in some embodiments, the method 2200, further may include a step 2206 of receiving, using the communication device 1402, a training regulatory data from the training regulatory database based on the training regulatory query data. Further, the generating of the enterprise output data may be further based on the training regulatory data. Further, the enterprise output data includes a regulatory complied training program data.

In some embodiments, the training regulatory data conforms to one or more standards.

In some embodiments, the one or more standards includes Occupational Safety and Health Administration (OSHA) standard.

In some embodiments, the one or more standards includes Environmental Protection Agency (EPA) standard.

In some embodiments, one or more standards includes National Institute of Standards and Technology (NIST) standard.

In some embodiments, the one or more standards includes Cybersecurity Infrastructure Security Agency (CISA) standard.

In some embodiments, the training regulatory data includes a training regulatory version data representing a real-time version information of the training regulatory data.

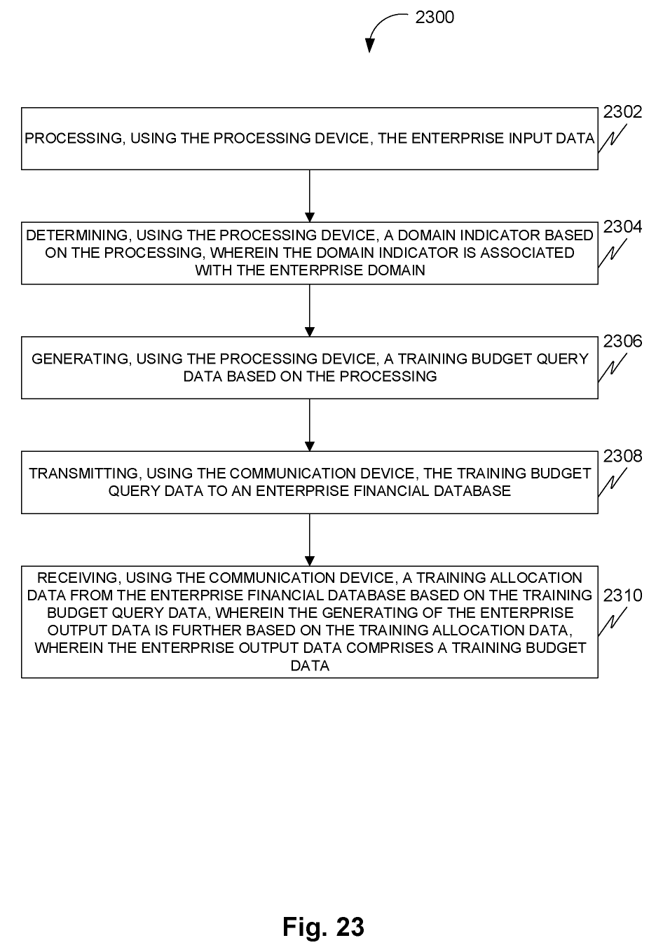

FIG. 23 illustrates a flowchart of a method 2300 of provisioning a neural network including receiving, using the communication device 1402, a training allocation data from the enterprise financial database, in accordance with some embodiments. Further, in some embodiments, the two or more AI agent modules may include an employee training AI agent module may be configured for generating an employee training program data. Further, the generating further may include a step 2302 of processing, using the processing device 1404, the enterprise input data. Further, the generating further may include a step 2304 of determining, using the processing device 1404, a domain indicator based on the processing. Further, the domain indicator may be associated with the enterprise domain. Further, the generating further may include a step 2306 of generating, using the processing device 1404, a training budget query data based on the processing. Further, the generating further may include a step 2308 of transmitting, using the communication device 1402, the training budget query data to an enterprise financial database. Further, the generating further may include a step 2310 of receiving, using the communication device 1402, a training allocation data from the enterprise financial database based on the training budget query data. Further, the generating of the enterprise output data may be further based on the training allocation data. Further, the enterprise output data includes a training budget data.

In some embodiments, the training allocation data conforms to one or more standards.

In some embodiments, the one or more standards includes Generally Accepted Accounting Principles (GAAP) standard.

In some embodiments, the one or more standards includes Sarbanes-Oxley Act (SOX)standard.

In some embodiments, the generating of the training budget data conforms to one or more standards.

In some embodiments, one or more standards includes Occupational Safety and Health Administration (OSHA)standard.

In some embodiments, the one or more standards includes Environmental Protection Agency (EPA)standard.

In some embodiments, the one or more standards includes National Institute of Standards and Technology (NIST) standard.

In some embodiments, the one or more standards includes Cybersecurity, Infrastructure Security Agency (CISA) standard.

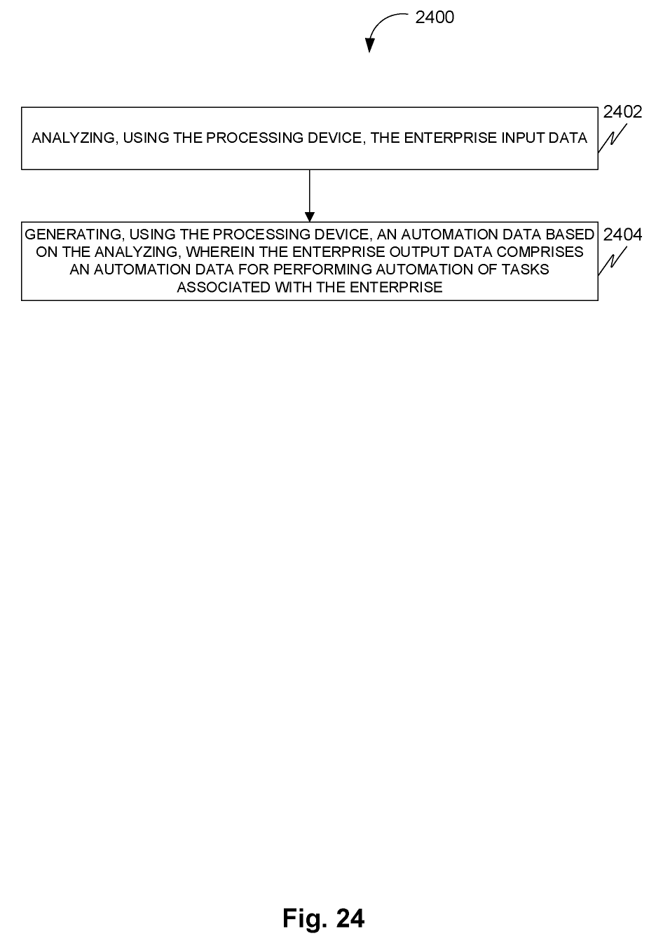

FIG. 24 illustrates a flowchart of a method 2400 of provisioning a neural network including generating, using the processing device 1404, an automation data, in accordance with some embodiments. Further, in some embodiments, the two or more AI agent modules may include a mechanization AI agent module may be configured for automation of task associated with the enterprise based on the enterprise input data, the method 2400 may include a step 2402 of analyzing, using the processing device 1404, the enterprise input data. Further, the two or more AI agent modules may include a mechanization AI agent module may be configured for automation of task associated with the enterprise based on the enterprise input data, the method 2400 may include a step 2404 of generating, using the processing device 1404, an automation data based on the analyzing. Further, the enterprise output data includes an automation data for performing automation of tasks associated with the enterprise.

In some embodiments, the automation data represents a resource scheduling data.

In some embodiments, the automation data represents a logistics management data.

In some embodiments, the automation data represents a process automation data.

In some embodiments, the generating of the automation data may be based on the quantum enhanced neural network. Further, the generating of the automation data includes a first generating of a first automation data at a first time instant and a second generating of a second automation data at a second time instant. Further, the second time instant occurs subsequent to the first time instant. Further, the generating of the second automation data may be further based on the first automation data.

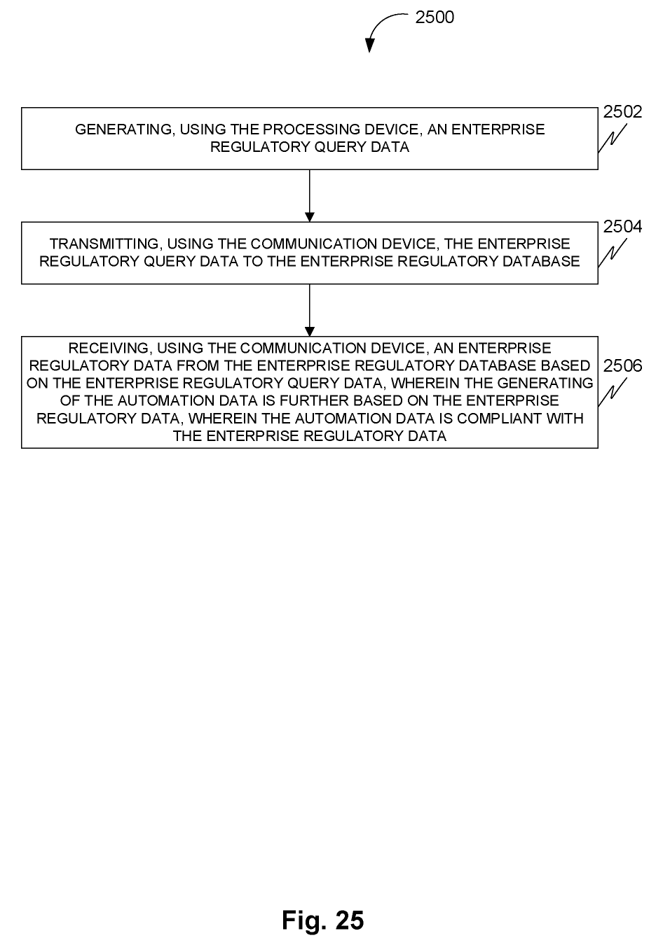

FIG. 25 illustrates a flowchart of a method 2500 of provisioning a neural network including receiving, using the communication device 1402, an enterprise regulatory data from the enterprise regulatory database, in accordance with some embodiments. Further, in some embodiments, the method 2500 further may include a step 2502 of generating, using the processing device 1404, an enterprise regulatory query data. Further, in some embodiments, the method 2500 further may include a step 2504 of transmitting, using the communication device 1402, the enterprise regulatory query data to the enterprise regulatory database. Further, in some embodiments, the method 2500 further may include a step 2506 of receiving, using the communication device 1402, an enterprise regulatory data from the enterprise regulatory database based on the enterprise regulatory query data. Further, the generating of the automation data may be further based on the enterprise regulatory data. Further, the automation data may be compliant with the enterprise regulatory data.

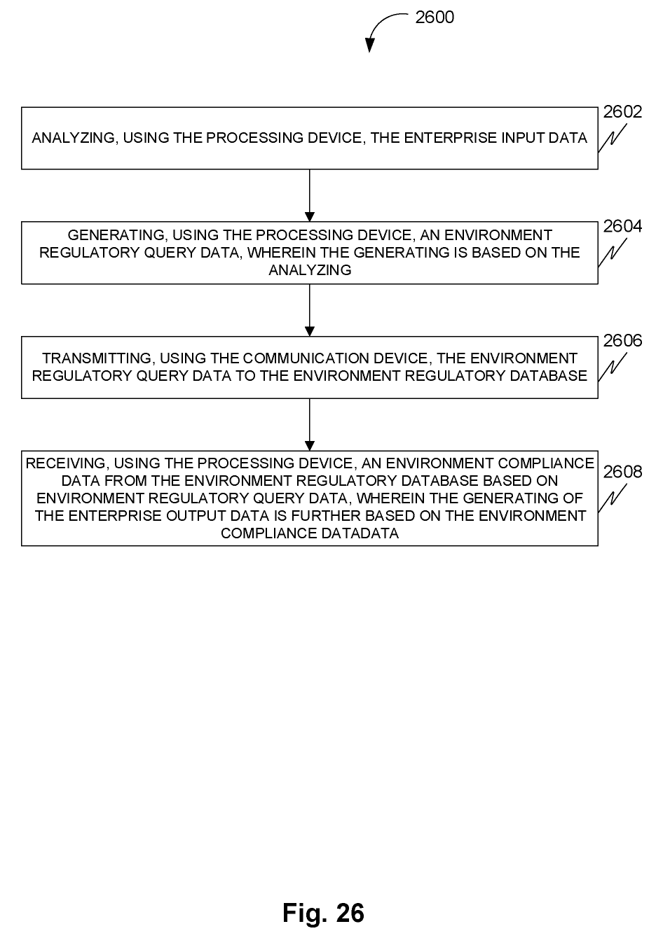

FIG. 26 illustrates a flowchart of a method 2600 of provisioning a neural network including receiving, using the processing device 1404, an environment compliance data from the environment regulatory database, in accordance with some embodiments. Further, in some embodiments, the two or more AI agent modules may include an environmental AI agent module may be configured for monitoring and reporting of environmental impact associated with the enterprise input data, the method 2600 may include a step 2602 of analyzing, using the processing device 1404, the enterprise input data. Further, the two or more AI agent modules may include an environmental AI agent module may be configured for monitoring and reporting of environmental impact associated with the enterprise input data, the method 2600 may include a step 2604 of generating, using the processing device 1404, an environment regulatory query data. Further, the generating may be based on the analyzing. Further, the two or more AI agent modules may include an environmental AI agent module may be configured for monitoring and reporting of environmental impact associated with the enterprise input data, the method 2600 may include a step 2606 of transmitting, using the communication device 1402, the environment regulatory query data to the environment regulatory database. Further, the two or more AI agent modules may include an environmental AI agent module may be configured for monitoring and reporting of environmental impact associated with the enterprise input data, the method 2600 may include a step 2608 of receiving, using the processing device 1404, an environment compliance data from the environment regulatory database based on environment regulatory query data. Further, the generating of the enterprise output data may be further based on the environment compliance data.

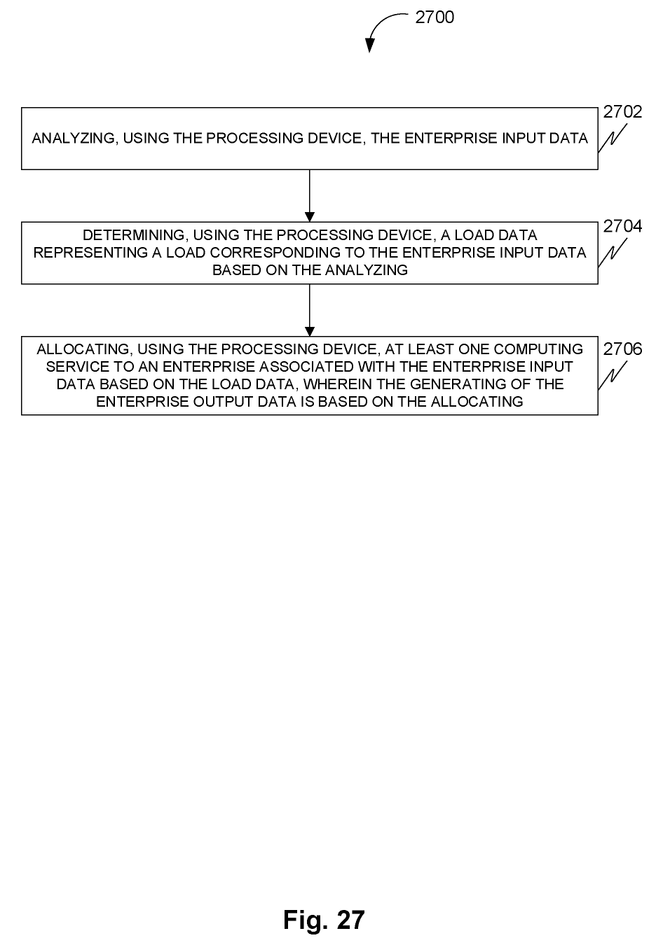

FIG. 27 illustrates a flowchart of a method 2700 of provisioning a neural network including allocating, using the processing device 1404, at least one computing service to an enterprise associated with the enterprise input data, in accordance with some embodiments. Further, in some embodiments, the method 2700, further may include a step 2702 of analyzing, using the processing device 1404, the enterprise input data. Further, in some embodiments, the method 2700, further may include a step 2704 of determining, using the processing device 1404, a load data representing a load corresponding to the enterprise input data based on the analyzing. Further, in some embodiments, the method 2700, further may include a step 2706 of allocating, using the processing device 1404, one or more computing services to an enterprise associated with the enterprise input data based on the load data. Further, the generating of the enterprise output data may be based on the allocating.

In some embodiments, the load represents one or more of a user traffic data representing a number of users associated with the enterprise input data and a dataset magnitude data representing a size of the enterprise input data.

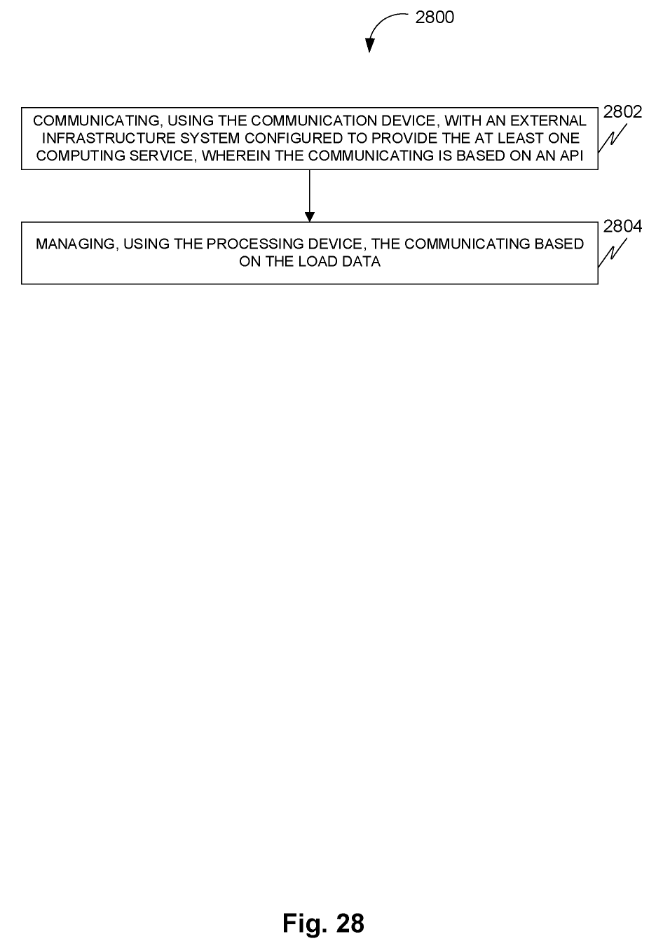

FIG. 28 illustrates a flowchart of a method 2800 of provisioning a neural network including managing, using the processing device 1404, the communicating, in accordance with some embodiments. Further, in some embodiments, the method 2800 further may include a step 2802 of communicating, using the communication device 1402, with an external infrastructure system which may be configured to provide the one or more computing services. Further, the communicating may be based on an API. Further, in some embodiments, the method 2800 further may include a step 2804 of managing, using the processing device 1404, the communicating based on the load data.

In some embodiments, the method 1600 may further include encrypting, using a quantum encryption technique, the enterprise output data to obtain an encrypted enterprise output data. Further, the encrypting may be based on the quantum enhanced neural network. Further, the enterprise output data includes the encrypted enterprise output data in lieu of the enterprise output data.

In some embodiments, the quantum encryption technique includes one or more of a quantum key distribution technique and a post quantum encryption technique.

In some embodiments, the quantum key distribution technique uses quantum-based key exchanges to establish a communication between the processing device 1404 and the enterprise device, the method 1600 further comprising detecting, using the processing device 1404, one or more of an intruder device intercepting the communication.

In some embodiments, the post quantum encryption technique uses a cryptographic system which may be configured to secure against both quantum and classical computing systems and interoperate with existing communication protocols.

In some embodiments, the method 1600 may further include detecting, using the processing device 1404, of an anomaly in the enterprise input data. Further, the detecting may be based on the quantum enhanced neural network.

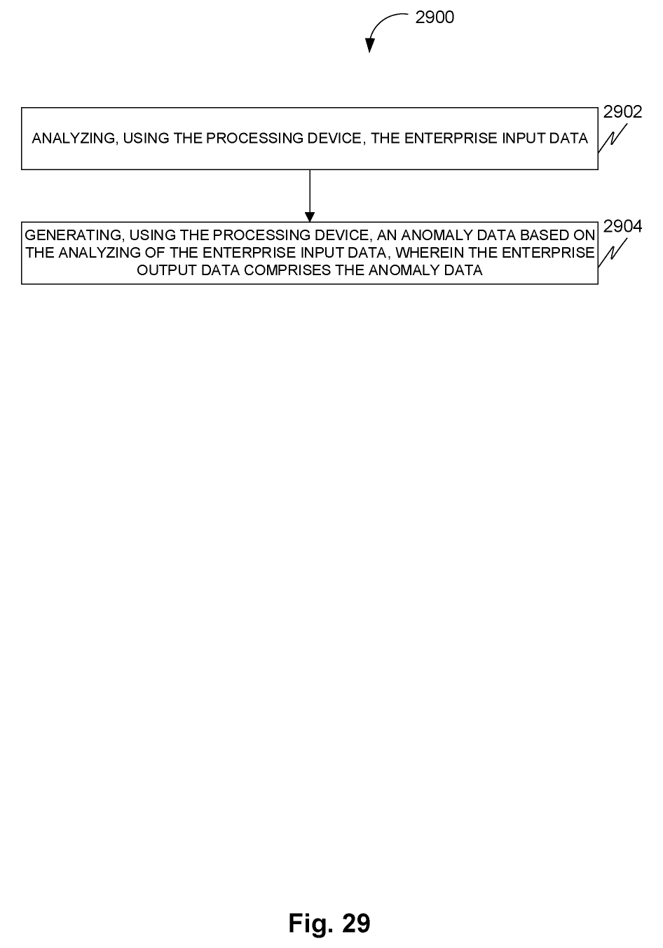

FIG. 29 illustrates a flowchart of a method 2900 of provisioning a neural network including generating, using the processing device 1404, an anomaly data, in accordance with some embodiments. Further, in some embodiments, the method 2900 may include a step 2902 of analyzing, using the processing device 1404, the enterprise input data. Further, the method 2900 may include a step 2904 of generating, using the processing device 1404, an anomaly data based on the analyzing of the enterprise input data. Further, the enterprise output data includes the anomaly data.

In some embodiments, the anomaly includes a data anomaly. Further, the data anomaly represents an anomaly in a transaction data comprised in the enterprise input data.

In some embodiments, the anomaly represents a security breach at the enterprise device associated with the enterprise.

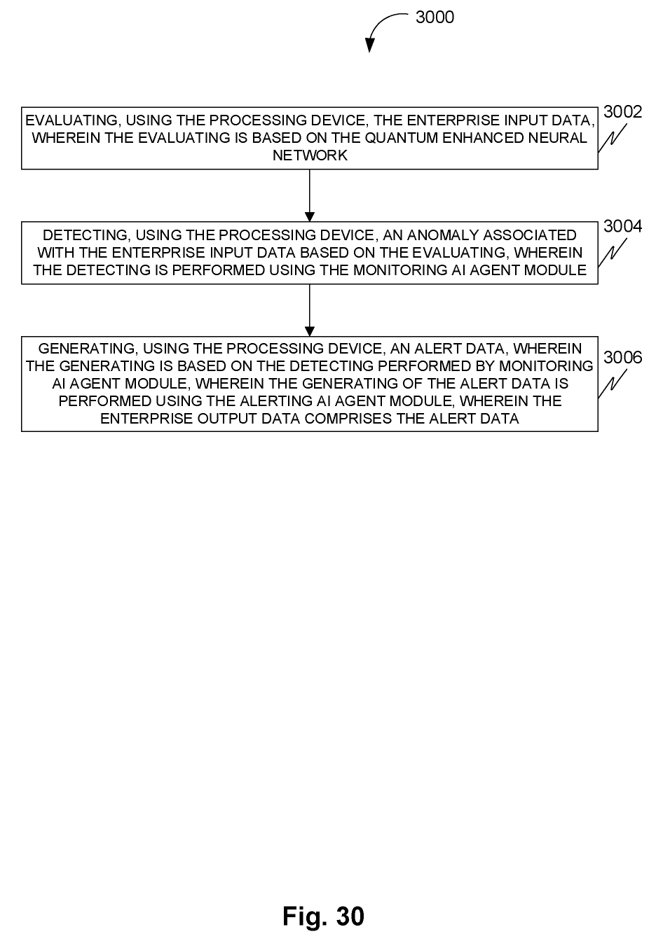

FIG. 30 illustrates a flowchart of a method 3000 of provisioning a neural network including generating, using the processing device 1404, an alert data, in accordance with some embodiments. Further, in some embodiments, the two or more AI agent modules may include a monitoring AI agent module and an alerting AI agent module, the method 3000 may include a step 3002 of evaluating, using the processing device 1404, the enterprise input data. Further, the evaluating may be based on the quantum enhanced neural network. Further, the method 3000 may include a step 3004 of detecting, using the processing device 1404, an anomaly associated with the enterprise input data based on the evaluating. Further, the detecting may be performed using the monitoring AI agent module. Further, the method 3000 may include a step 3006 of generating, using the processing device 1404, an alert data. Further, the generating may be based on the detecting performed by monitoring AI agent module. Further, the generating of the alert data may be performed using the alerting AI agent module. Further, the enterprise output data includes the alert data.

In some embodiments, the anomaly includes one or more of a data anomaly. Further, the data anomaly represents an anomaly in a transaction data comprised in the enterprise input data.

In some embodiments, the anomaly represents a security breach at the enterprise device associated with the enterprise.

In some embodiments, the disclosed system provides a software-based artificial intelligence platform that inherently improves the operation of computer systems that perform regulatory compliance analysis by addressing technical limitations associated with static rule engines, batch-oriented processing architectures, and computational inefficiency in conventional compliance automation systems. In particular, existing systems often rely on manually curated rule sets that are evaluated sequentially and require repeated full recomputation when regulatory data changes, thereby increasing latency, processor load, and memory consumption. In some embodiments, the disclosed system may include a quantum-inspired neural network architecture that dynamically adjusts internal optimization parameters during execution, thereby improving the underlying technology of neural network-based data processing. The technical problem addressed is the inefficiency of classical gradient-based optimization techniques when applied to high-dimensional, heterogeneous regulatory data streams. In some embodiments, the given improvement may be implemented by encoding regulatory constraints as weighted nodes within hidden layers of the neural network and iteratively adjusting those weights using probabilistic sampling techniques inspired by quantum annealing. In some embodiments, the same improvement may be implemented by using tensor-based state representations that allow simultaneous exploration of multiple optimization paths, thereby reducing convergence time and computational overhead. As a result, the specific technology being improved is neural network optimization for real-time compliance computation.

In some embodiments, the disclosed system inherently improves real-time data processing technology by enabling non-blocking compliance determination that responds to incremental updates rather than requiring full dataset recomputation. The technical problem addressed is that traditional compliance engines typically perform full re-evaluation of compliance rules upon receipt of new regulatory input data, which causes processing delays and system downtime. In some embodiments, the disclosed system may include a change-detection mechanism that identifies version deltas or semantic differences within regulatory data streams and triggers partial neural network recomputation limited to affected model parameters. In some embodiments, the given may be implemented by hashing regulatory rule segments and comparing hash values to identify modified portions, while in other embodiments it may be implemented using vector embeddings to detect semantic drift between successive regulatory versions, improving the technology of real-time data processing by reducing unnecessary computation and enabling continuous system availability.

In some embodiments, the disclosed system inherently improves automated semantic analysis technology by enabling context-aware regulatory applicability determination. The technical problem addressed is that conventional systems often apply all regulatory rules uniformly, regardless of enterprise context, resulting in false positives and excessive processing. In some embodiments, the disclosed system may include semantic attribute extraction mechanisms that analyze operational input data to identify business functions, industry classifications, or operational states. In some embodiments, the given aspect may be implemented using transformer-based language models that generate embeddings for enterprise operational descriptions and map those embeddings to regulatory applicability rules stored in a compliance knowledge graph. In other embodiments, rule applicability may be determined using probabilistic inference models that associate operational metadata with regulatory scopes, improving the technology of automated semantic reasoning in compliance systems.

In some embodiments, the disclosed system inherently improves adaptive machine learning system technology by enabling automatic regulatory rule evolution within a deployed neural network. The technical problem addressed is that conventional compliance systems require manual retraining or redeployment when regulatory frameworks evolve. In some embodiments, the disclosed system may include version-aware neural network layers that dynamically adjust rule weights when regulatory input data reflects a version change. In some embodiments, the given aspect may be implemented by maintaining multiple concurrent rule-weight states and selecting an optimal state based on detected regulatory version metadata. In other embodiments, reinforcement learning techniques may be used to reward compliance outcomes that align with updated regulatory interpretations, improving the technology of adaptive machine learning systems by enabling live model evolution without service interruption.

In some embodiments, the disclosed system inherently improves distributed computing resource management technology by dynamically adjusting computational resource allocation based on measured compliance processing latency. The technical problem addressed is that static resource allocation in cloud-based systems often leads to overprovisioning or performance bottlenecks. In some embodiments, the disclosed system may include latency monitoring mechanisms that measure processing time associated with compliance determination and compute workload metrics in real time. In some embodiments, the said workload metrics may be used to automatically adjust processing threads, memory allocation, or execution priority within a virtualized environment, improving the technology of cloud-based resource orchestration by enabling workload-aware scaling specific to compliance computation tasks.

In some embodiments, the disclosed system inherently improves auditability and traceability technology by generating and storing trace data that represents a sequence of compliance determinations. The technical problem addressed is that many AI-driven compliance systems operate as black boxes and may not produce verifiable computational histories. In some embodiments, the disclosed system may include mechanisms that generate trace data capturing intermediate neural network states, rule evaluations, and decision pathways. In some embodiments, the said trace data may be cryptographically linked to compliance output data, while in other embodiments it may be stored as a directed acyclic graph representing decision flow, improving the technology of compliance verification and audit systems by enabling reproducible and inspectable AI decisions.

In some embodiments, the disclosed system inherently improves cybersecurity technology by securing compliance input data during active neural network processing. The technical problem addressed is that sensitive regulatory and operational data may be exposed during in-memory processing. In some embodiments, the disclosed system may include post-quantum encryption techniques applied to data during processing rather than solely at rest or in transit. In some embodiments, homomorphic encryption or secure enclave execution may be used to ensure that compliance determination occurs on encoded data without exposing plaintext values, improving the technology of secure computation within AI-driven compliance systems.

In some embodiments, the disclosed system inherently improves data interoperability technology by transforming compliance output data into machine-readable schemas that conform to regulatory format definitions. The technical problem addressed is that compliance outputs are often generated in proprietary or unstructured formats that are incompatible with downstream systems. In some embodiments, schema transformation may be implemented using declarative schema mappings stored within the processing device, while in other embodiments schema validation may be performed using formal grammar definitions or ontology-based constraints, improving the technology of regulatory data exchange and interoperability.

In some embodiments, additional technical improvements may be incorporated to further enhance the disclosed system. In some embodiments, the disclosed system may include a federated learning mechanism that allows compliance models to be improved using distributed enterprise data without centralizing sensitive operational data. The technical problem addressed is the inability to leverage cross-enterprise learning due to data privacy constraints. In some embodiments, model updates may be exchanged as encrypted parameter deltas rather than raw data, thereby improving the technology of privacy-preserving machine learning.

In some embodiments, the disclosed system may include an explainable AI mechanism that generates structured explanation data corresponding to compliance determinations. The technical problem addressed is the lack of transparency in neural network-based decisions. In some embodiments, explanation data may be generated by tracing neuron activation paths, while in other embodiments symbolic rule approximations may be derived from trained models, improving the technology of explainable artificial intelligence.

In some embodiments, the invention may include temporal reasoning mechanisms that analyze compliance status trends over time. The technical problem addressed is that conventional systems evaluate compliance as a static snapshot. In some embodiments, temporal models such as recurrent neural networks or time-series transformers may be used to detect emerging compliance risks, improving the technology of predictive compliance analytics.

In some embodiments, the invention may include automated regulatory conflict resolution mechanisms. The technical problem addressed is that overlapping regulations may impose contradictory requirements. In some embodiments, conflict resolution may be implemented using priority graphs or constraint satisfaction solvers that operate within the processing device, improving the technology of automated rule reconciliation.

In some embodiments, the invention may include self-validation mechanisms that periodically test compliance determination accuracy using synthetic regulatory scenarios. The technical problem addressed is model drift and silent failure. In some embodiments, synthetic test cases may be generated using generative models trained on historical regulatory data, improving the technology of AI system reliability and self-monitoring.

Although the invention has been explained in relation to its preferred embodiment, it is to be understood that many other possible modifications and variations can be made without departing from the spirit and scope of the invention as hereinafter claimed.

What is claimed is:

1. A method of facilitating automated regulatory compliance determination, the method comprising:
receiving, using a communication device, a compliance input data from a regulatory data source;
receiving, using the communication device, an operational input data from an enterprise system;
determining, using a processing device, a compliance status data by processing the compliance input data and the operational input data using a quantum-inspired neural network;
generating, using the processing device, a compliance output data based on the compliance status data;
storing, using a storage device, the compliance output data; and
transmitting, using the communication device, the compliance output data to a client system.

2. The method of claim 1 further comprising:
monitoring, using the processing device, a change indicator within the compliance input data;
triggering, using the processing device, execution of the quantum-inspired neural network in response to the change indicator; and
updating, using the processing device, the compliance status data without interrupting availability of the method.

3. The method of claim 1 further comprising:
extracting, using the processing device, a semantic attribute from the operational input data;
mapping, using the processing device, the semantic attribute to a regulatory applicability rule; and
refining, using the processing device, the determining of the compliance status data based on the regulatory applicability rule.

4. The method of claim 1 further comprising:
detecting, using the processing device, a version change within the compliance input data;
recomputing, using the processing device, a rule weight within the quantum-inspired neural network based on the version change; and
modifying, using the processing device, the compliance status data using the recomputed rule weight.

5. The method of claim 1 further comprising:
classifying, using the processing device, the operational input data into an industry category;
selecting, using the processing device, an industry-specific compliance model associated with the industry category; and
applying, using the processing device, the industry-specific compliance model during generation of the compliance output data.

6. The method of claim 1 further comprising:
measuring, using the processing device, a processing latency associated with determination of the compliance status data;
computing, using the processing device, a workload metric based on the processing latency; and
dynamically adjusting, using the processing device, an allocation of a scalable computing resource based on the workload metric.

7. The method of claim 1 further comprising:
generating, using the processing device, a trace data representing a sequence of compliance determinations;
associating, using the processing device, the trace data with the compliance output data; and
storing, using the storage device, the trace data for audit verification.

8. The method of claim 1 further comprising:
initializing, using the processing device, a quantum-inspired optimization parameter;
iteratively updating, using the processing device, the quantum-inspired optimization parameter during execution of the quantum-inspired neural network; and
reducing, using the processing device, a computational resource usage while maintaining accuracy of the compliance status data.

9. The method of claim 1 further comprising:
encoding, using the processing device, the compliance input data using a post-quantum encryption scheme;
validating, using the processing device, integrity of the encoded compliance input data prior to determination of the compliance status data; and
preventing, using the processing device, an unauthorized modification of the compliance input data during processing.

10. The method of claim 1 further comprising:
transforming, using the processing device, the compliance output data into a machine-readable compliance schema;
validating, using the processing device, the machine-readable compliance schema against a regulatory format definition; and
generating, using the processing device, a standardized regulatory reporting data conforming to the regulatory format definition.

11. A system for facilitating automated regulatory compliance determination, the system comprising:
a communication device configured for:
receiving a compliance input data from a regulatory data source;
receiving an operational input data from an enterprise system; and
transmitting a compliance output data to a client system;
a processing device communicatively coupled with the communication device, wherein the processing device is configured for:
determining a compliance status data by processing the compliance input data and the operational input data using a quantum-inspired neural network; and
generating the compliance output data based on the compliance status data; and
a storage device communicatively coupled with the processing device, wherein the storage device is configured for storing the compliance output data.

12. The system of claim 11, wherein the processing device is further configured for:
monitoring a change indicator within the compliance input data;
triggering execution of the quantum-inspired neural network in response to the change indicator; and
updating the compliance status data without interrupting system availability.

13. The system of claim 11, wherein the processing device is further configured for:
extracting a semantic attribute from the operational input data;
mapping the semantic attribute to a regulatory applicability rule; and
refining determination of the compliance status data based on the regulatory applicability rule.

14. The system of claim 11, wherein the processing device is further configured for:
detecting a version change within the compliance input data;
recomputing a rule weight within the quantum-inspired neural network based on the version change; and
modifying the compliance status data using the recomputed rule weight.

15. The system of claim 11, wherein the processing device is further configured for:
classifying the operational input data into an industry category;
selecting an industry-specific compliance model associated with the industry category; and
applying the industry-specific compliance model during generation of the compliance output data.

16. The system of claim 11, wherein the processing device is further configured for:
measuring a processing latency associated with determination of the compliance status data;
computing a workload metric based on the processing latency; and
dynamically adjusting allocation of a scalable computing resource based on the workload metric.

17. The system of claim 11, wherein the processing device is further configured for:
generating a trace data representing a sequence of compliance determinations; and
associating the trace data with the compliance output data, wherein the storage device is further configured for storing the trace data for audit verification.

18. The system of claim 11, wherein the processing device is further configured for:
initializing a quantum-inspired optimization parameter;
iteratively updating the quantum-inspired optimization parameter during execution of the quantum-inspired neural network; and
reducing computational resource usage while maintaining accuracy of the compliance status data.

19. The system of claim 11, wherein the processing device is further configured for:
encoding the compliance input data using a post-quantum encryption scheme;
validating integrity of the encoded compliance input data prior to determination of the compliance status data; and
preventing unauthorized modification of the compliance input data during processing.

20. The system of claim 11, wherein the processing device is further configured for:
transforming the compliance output data into a machine-readable compliance schema;
validating the machine-readable compliance schema against a regulatory format definition; and
generating a standardized regulatory reporting data conforming to the regulatory format definition.
